(19) United States
(12) Patent Application Publication
(10) Pub. No.: US 2022/0142209 A1
(43) Pub. Date: May 12, 2022

(54) METHODS AND COMPOSITIONS FOR IMPROVING THE TASTE OF DIET COLA SODAS AND OTHER BEVERAGES

(71) Applicant: Gregory AHARONIAN, Belmont, MA (US)

(72) Inventor: Gregory AHARONIAN, Belmont, MA (US)

(21) Appl. No.: 17/432,747

(22) PCT Filed: Feb. 19, 2020
(86) PCT No.: PCT/US20/18828

§ 371 Date: Aug. 20, 2021

Related U.S. Application Data
(60) Provisional application No. 62/808,045, filed on Feb. 20, 2019.

(51) Int. Cl. A23L 2/56; A23L 2/385; A23L 27/00

(52) U.S. Cl. CPC A23L 2/56; A23V 2002/00; A23L 27/88; A23L 2/385

(57) ABSTRACT

An improved carbonated beverage comprises adding ethyl benzoate or a coca leaf extract to a diet soda, in particular, a diet cola soda. An improved diet cola beverage comprises an extract of the coca leaf. Such improved beverages can additionally comprise sugar, glucose or an artificial sweetener. The extract of coca leaf plant may be decocainized, and provided in either liquid or powder form. One ratio of diet cola beverage product and the extract of the coca leaf plant is a ratio by weight of approximately 22:1 to 44:1 of beverage:extract.

### RELATED APPLICATIONS

The present application claims the benefit of U.S. Provisional Patent Application No. 62/808,045 filed Feb. 20, 2019, the disclosure of which is incorporated herein by reference in its entirety.

### TECHNICAL FIELD

This disclosure relates to beverage products, in particular to, but not limited to, improving the taste and/or aroma of artificially sweetened beverages, especially cola sodas.

### SPECIFICATION DISCLAIMER

A word or phrase enclosed in single quotes (‘ ’) signifies that it is not to be evaluated for meaning in that instance (for example, when first used in a definition of a term, such as ‘soda’), or signifies that it has no meaning for being (fatally) vague (for example, no Due Process Public Notice is provided by statute nor by Administrative guidance, such as ‘abstract’).

### BACKGROUND

In recent years, beverage and food companies have come under government attack and suffered consumer defections, one reason being that their products have large amounts of (added) sugar, in an era when consumers are consuming much more sugar each day than is recommended by government and medical groups such as the American Heart Association. These recommendations are based on an increasing amount of science that links this excessive added sugar consumption to diabetes, obesity, heart disease, cancer and Alzheimer's disease (and indirectly lung cancer, since cigarettes are hard to smoke without adding a few grams of sugar to each cigarette)—diseases which governments annually spend trillions to improve public health.

For example, Coca-Cola uses over two million tons of sugar each year in the U.S. This added sugar in beverages is being demonized as a harmful, mildly addictive drug, especially high fructose corn syrup, which can cause non-alcoholic fatty liver disease. In 2016 and 2017, Coca-Cola was sued three times in the U.S. for allegedly harming public health with its added-sugar beverages. Coca-Cola's annual 10-K report, starts their Risk Factor section with a warning of the risk to profits from these health concerns about sugar, risks such as lawsuits.

In response to consumer demand, Coca-Cola, Pepsico and other beverage manufacturers have introduced artificially-sweetened sodas such as DIET RITE® (the first in 1958), TAB®, DIET COKE® (introduced in 1982), COCA-COLA ZERO®, COCA-COLA ZERO SUGAR®, and DIET PEPSI®, replacing some or all of the sugar with sweetish chemicals such as aspartame, acesulfame, sucralose, saccharin and others. Unfortunately, some of these chemicals also have an unpleasant taste, e.g., due to chemicals such as acesulfame with sulfur and potassium, and sucralose with chlorine. A natural sweetener, stevia, is unpleasant enough that it is still used with sugar, such as in COCA-COLA LIFE® soda, for which a 12 ounce can of contains 24 grams of sugar (and some stevia) as compared to regular COCA-COLA® with 39 grams of sugar—about a 40% reduction.

Cola sodas comprise about half of the soda beverage market, valued at over $200 billion/year in sales. The three biggest brands of cola sodas are COCA-COLA®, DIET COKE® and PEPSI®, an extremely competitive space where these huge multinationals seize the slightest innovation to be competitive, desperate for any new additive such as using stevia to gain an edge in a multi-year trillion dollar industry. In the United States, circa 2016, the Coca-Cola Company annually sells about 4.5 billion liters of COCA-COLA®, 2.3 billion liters of DIET COKE® and 0.8 billion liters of COKE ZERO®. Because of the unpleasant taste due to the artificial sweeteners, which many describe as a “metallic” taste, beverages such as DIET COKE®, COCA-COLA ZERO®, DIET PEPSI® and others have never surpassed sugary cola sodas in sales. In blind taste tests, few consumers are fooled into thinking that diet cola sodas are their sugary counterparts.

Failure of Others: Despite hundreds of billions of dollars of sales of soda beverages each year, and spending hundreds of millions of dollars in research and development by those ‘skilled’ (e.g., Coca-Cola has six huge R&D centers around the world linked to External Technology and Assessment hubs, with one R&D center in Mexico, but no R&D centers in the coca-leaf countries of Colombia, Peru or Bolivia, the ‘obvious’ countries for a cola soda R&D center), all those who are ‘skilled’ have failed to make drinking diet colas as pleasant an experience as sugary sodas, a failure that prevents diet colas from displacing, to a greater extent, sugary colas in terms of consumer sales (except where, e.g., sugary drinks are heavily taxed). On the order of 100 billion cans of (sugary and diet) cola soda are sold each year (over 3 billion cases of 24 cans), a huge (i.e. in terms of billions of dollars) motivation for those ‘skilled’ to try anything and everything to make a better soda while suffering stagnant sales.

The failure of others to improve the experience of drinking artificially sweetened cola sodas is seen in a common response when drinking DIET COKE®. At the beginning of the first mouthful, there is enough “Coca-Cola” taste and sweetness from the artificial sweetener(s) to briefly create the sensation of a “regular Coca-Cola” experience. But then the unpleasantness due to the artificial sweetener(s) becomes more apparent, so that further drinking becomes less appealing. Further, the effects of these sweetener(s) linger through succeeding mouthfuls of DIET COKE®, so that further mouthfuls don't provide more of a “regular Coca-Cola” experience. Most consumers finish the DIET COKE® much because of their sunk costs, rather than that they truly enjoy the experience. Only by adding one or two more artificial sweeteners (such as with COKE ZERO®) can the taste be at least made sweeter, at the expense of the cola soda taste (which is primarily the tastes of sweet and salt).

Difficulties in Using Artificial Sweeteners in Sodas

For decades, cola soda companies and others have tried to find any improved mixtures of artificial sweeteners that make their diet sodas more pleasant. The competitive history of these companies guessing at a variety of mixtures over the decades is evidence of the failure to fully understand these sweeteners' biochemical effects. Diet Coke only uses aspartame (as does Diet Dr. Pepper), while Coca-Cola Zero and Coca-Cola Zero Sugar use both aspartame and acesulfame, as do Coca-Cola Vanilla Zero, Coca-Cola Cherry Zero, Diet Coke Lime and Coca-Cola Orange Fanta Zero. Jones' Zero Calorie Black Cherry Soda uses just sucralose, while Coca-Cola's Fresca Toronja uses sucralose and acesulfame, as do Diet Coke with Splenda, Monster Energy's Lo-Carb Energy drink (has 3 grams of sugar), Monster Energy's Energy Ultra Black (with 1 gram of erythritol) and Diet Shasta Grapefruit. One other difference between Diet Coke and Coca-Cola Zero is that Diet Coke uses citric acid, while Coca-Cola Zero uses sodium citrate (both chemicals acting as acidity regulators). Modern formulations of Coca-Cola's Tab use aspartame and saccharin. Diet Pepsi has gone from using saccharin to using aspartame (as does Diet Coke) to now using sucralose and acesulfame, with SodaStream Diet Cola Soda Mix also using sucralose and acesulfame. Diet A&W Root Beer uses aspartame and acesulfame, Diet IBC Root Beer uses aspartame and saccharin, while Cott Beverages' Stars & Stripes Root Beer uses aspartame and acesulfame while also still using 23 grams of sugars per 12 ounces. Many consumers in Latin America prefer sweeter versions of foods and beverages. For example, in the U.S., Diet Pepsi uses sucralose and acesulfame, but in Costa Rica, Diet Pepsi uses sucralose, acesulfame and aspartame. A Colombian sports drink, VIVE100%® (açai version), also uses three artificial sweeteners—sucralose, acesulfame and aspartame, while disclosing a bit of its formulation on the label: guarana extract (25 milligrams per 100 milliliters), green tea extract (5 milligrams per 100 milliliters) and acai extract (8 milligrams per 100 milliliters).

The world's first diet cola, Royal Crown DIET RITE®, launched in 1958, used saccharin and cyclamate, as did Coca-Cola's soon-to-follow product, TAB®. Cyclamate was designated as Generally Recognized As Safe (GRAS) by the U.S. FDA in 1958. However, based on now-discredited animal studies funded by the sugar industry (financially threatened by a 1:10 combination of saccharin and cyclamate that has little of an unpleasant taste) the FDA removed cyclamate's GRAS designation in 1969. Today, though, most of the world's largest economies (such as Europe) approve the use of cyclamate in beverages, and filings have been made to the FDA to have the agency re-designate cyclamate as GRAS, based on scientific data. However, in the United States, the major soda companies have abandoned cyclamate and saccharin for these newer sweeteners, which have their health concerns, e.g., aspartame, acesulfame and sucralose.

Coke Zero Sugar U.S. versus Coke Zero Sugar Brazil

The difficulties that cola soda companies have in understanding and mastering combinations of artificial sweeteners is seen in a comparison of the composition of Coke Zero Sugar U.S. versus Coke Zero Sugar Brazil. In 2017, Coca-Cola introduced Coca-Cola Zero Sugar, a slightly “sweeter” reformulation of its Coca-Cola Zero, both of which use aspartame and acesulfame. However, in Brazil, Coca-Cola Zero Açúcar uses aspartame, acesulfame and cyclamate (Coca-Cola also uses cyclamate in its diet cola products in Germany), with little change in taste, raising the question as to why bother adding cyclamate. Clearly, after 60 years of using artificial sweeteners, cola soda companies have failed to create diet colas with no unpleasant aftertaste, let alone provide the full experience of drinking their sugar-based cola sodas. Another failure with artificial sweeteners can be seen with PepsiCo's U.S. Pat. No. 6,265,012, “Reduction of Lingering Sweet Aftertaste of Sucralose”, which added about 10 parts per million of gallontannin (it is not known if DIET PEPSI® ever used this additive). U.S. Pat. No. 5,976,602, “Method of formulating acidified cola beverages”, issued in 1999, teaches various ratios of aspartame:acesulfame at different levels of pH to improve the taste of diet colas, but the technology of this patent has failed to have been used to improve the taste of diet colas. Two patent applications, U.S. Pat. Appl. 20020004092 and U.S. Pat. Appl. 20030096047, “Low calorie beverages containing high intensity sweeteners and arabinogalactan”, apparently disclosed technology enough of a market failure that the applications were abandoned.

Indeed, in the summer of 2017, Coca-Cola announced a $1 million prize to the first person/group in the public to find a new natural sweetener for its cola beverages (beyond the use of the known, and patented, stevia and monk fruit). It is ‘obvious’ that those ‘skilled’ at Coca-Cola have failed to fully understand the cola soda taste, since the company is only asking for a new sweetener, instead of also asking for any new natural flavoring additives (also due in part to Coca-Cola and PepsiCo for a long time NOT motivating inventors to discover new flavorings, since on their Web sites, the two companies forcefully state to everyone to NOT send them proposals involving new flavorings). For the near-trillion dollar soda industry, these highly ‘skilled’ ‘expect’ that the only way to improve diet sodas is to find a better sweetener. One motivation to not consider non-sweeteners to improve the taste of diet sodas can be seen in the apparent market failure of the technology of U.S. Pat. No. 5,474,791, “Beverages using tamarind extract”, where the beverages added extracts to the artificial sweeteners, especially aspartame.

Difficulties in Using Flavorings to Improve Cola Sodas

Coca-Cola has greatly exploited for marketing purposes its “vaulted trade secret”—its secret flavoring ingredients. Which is probably their only formulation secret, since in a little-known U.S. Federal Court decision from 1983, Coca-Cola disclosed the exact composition of one of its COCA-COLA® syrup and DIET COCA-COLA® syrup formulations except for the flavoring ingredients (see FIG. 1). What is left to discover are the exact amounts of flavoring ingredients. But for over 100 years, global research into Coca-Cola's flavoring ingredients has been almost non-existent. For example, to date, about 20,000 university theses and dissertations mention “Coca-Cola”. None include the data and embodiments for new flavoring ingredients disclosed herein. Only one thesis has tried to recreate at least the cola soda aroma, “Identification and characterization of potent odorants responsible for typical and storage-induced flavors of cola-flavored carbonated beverages”, written by Yaowapa Lorjaroenphon in 2012 for his PhD thesis at the University of Illinois at Urbana-Champaign. FIG. 11 lists a formula for a set of chemicals (and their concentrations) to create a cola aroma that in laboratory comparisons was very similar to that of a commercial cola soda (the thesis never identified the three cola sodas being analyzed). None of the new flavoring ingredients disclosed herein appear in FIG. 11.

Cola sodas have long been suspected to use small quantities of fruit oils, some of the fruits maybe including orange, lemon, lime, neroli, cinnamon and/or nutmeg. Two aromatic chemicals, limonene and cinnamaldehyde, and one aromatic family based on terpenes (including alpha-terpineol and gamma-terpinene) are all known to available in such fruit oils and also known by a few spectroscopic analyses to be present in cola sodas. The potential importance of two of these chemicals is signified in the two, if only two, patents from Coca-Cola and Pepsi dealing with these chemicals: U.S. Pat. No. 5,220,105, “Process for purifying d-limonene” (Coca-Cola, which does not mention sodas) and U.S. Pat. No. 8,431,178, “Increasing the concentration of terpene compounds in liquid” (PepsiCo), neither of which mention benzoates. FIG. 2 is table of some plants that can be the basis of essential oils used food preservation, taste and safety (many of which include the terpineols and limonene, as indicated). Despite the many possible flavorings from mixtures of these essential oils, and other essential oils, all those ‘skilled’ have failed to discover any such mixtures of such essential oils to improve the tastes and aromas of diet cola sodas. It is unknown if the cola soda companies still use extracts of the fruit oils, or just the main chemicals in these extracts.

While the original COCA-COLA® soda developed by John “Doc” Pemberton and Asa Candler made use of extracts of the coca leaf and kola nut—its Merchandise No. 5 ingredient, over time the company eliminated one, if not both (part of the trade secret). The kola nut extract probably has been eliminated because it is more cost effective to use industrial caffeine. The coca leaf extract probably has been eliminated because Coca-Cola doesn't find the minuscule amounts useful anymore as part of their sodas' taste and/or aroma. When Coca-Cola launched its infamous “New Coke” in 1985, it ‘unexpectedly’ didn't use Merchandise No. 5 (kola and coca flavorings) in its NEW COKE®, as ‘unexpected’ as the fact that Coca-Cola never used Merchandise No. 5 in its diet cola sodas. A reasonable assumption is that when Coca-Cola abandoned its NEW COKE® three months later (a competitive battle with PepsiCo involving just a 1% change in the sugar content of Coca-Cola sodas), and relaunched its “Classic” COKE®, that the company stopped using Merchandise No. 5 in that product as well. And it is a fact that PepsiCo has never discovered any commercial use of coca leaf extracts for its products, despite decades of intense competition of being second in the market to Coca-Cola, a huge motivation to try anything ‘obvious’.

Another failure of those ‘skilled’ is their inability to use commercial cola-soda flavorings to make the taste and/or aroma of diet cola sodas more like that of sugary cola sodas. For decades, companies such as International Flavor & Fragrance have sold cola flavorings. But none of these flavorings have motivated discovery of a diet cola soda that is as pleasant to drink as a sugary cola soda. FIG. 3 is a list of flavor additives for some food products from U.S. Pat. No. 4,404,184, titled “Flavoring with methyl-thio-2-methyl-2-pentenonate”, none apparently of use to those ‘skilled’ in improving cola sodas, with or without methyl-thio-2-methyl-2-pentenonate.

Another failure of those ‘skilled’ is their inability to use of components of COCA-COLA® and cola flavorings to make diet colas taste more like the taste of Coca-Cola soda. Vanilla was one of the original ingredients of COCA-COLA® (Merchandise No. 8). But vanilla is a powerful flavoring that often overwhelms the base taste of a beverage. This can be seen, for example, Coca-Cola's VANILLA ZERO® cola soda, the vanilla overwhelming the “Coca-Cola” taste. The failure of Coca-Cola's DIET COKE LIME® is that it is little more than the unpleasant taste of a diet cola with the tartness of lime. Neither have proven to be popular cola sodas.

Another failure of those ‘skilled’ is the lack of innovation by the giant ‘extraordinarily’ ‘skilled’ corporations of the cola soda industry. Most of Coca-Cola's recent patents with the word “taste” in the claims are just for patents on new sweeteners for Coca-Cola's beverages (for example, U.S. Pat. No. 9,173,425, “High-potency sweetener composition with vitamin and compositions sweetened therewith”). Coca-Cola has moved away from the pure “Coca-Cola” taste with some of its diet cola sodas, such as Diet Cherry Coke, Diet Vanilla Coke, Diet Coke with Lime, and Diet Coke with Citrus Zest (Coca-Cola did much the same with its first diet Cola, TAB®, with beverages such as Tab Lemon-Lime, and Tab Black Cherry), and in 2018, DIET COKE® with exotic fruits such as mango. Pepsi has its PEPSI FIRE® cinnamon flavored cola. In 2019, Coca-Cola launched ORANGE VANILLA COCA-COLA®, borrowing some of the taste of the 114-year old creamsicle popsicle.

Since the introduction of diet colas in 1950s, the cola beverage industry with its multi-hundred-billion dollars per year in sales, has failed to satisfy consumer demand for a really “Coca Cola”-tasting cola soda beverage free of mildly addictive, harmful sugar (especially fructose), a failure magnified by the hundreds of millions of dollars spent on beverage research by these ‘skilled’ experts to improve cola sodas.

In light of hundreds of billions of dollars of profits and expenditures across the decades by Coca-Cola (and PepsiCo), one meaning of utterly not ‘obvious’ is any use and/or patenting of publicly known flavorings, aromatics and/or sweeteners to improve the taste and/or aroma of DIET COKE® and COKE ZERO® that are available to, but NOT used by, Coca-Cola (and PepsiCo), two extremely competitive companies with many highly-paid beverage scientists ‘extraordinarily’ ‘skilled’ in whatever ‘arts’.

Artificial Sweeteners. For example, in 1931 scientists identified the glycosides in stevia leaves that make stevia extracts to be a calorie-free natural sweetener. Not so ‘obvious’ to use in cola sodas since it required 70 years for Coca-Cola and PepsiCo to start using stevia extracts in their cola sodas. Similarly, in 1937, a scientist discovered an artificial sweetener, sodium cyclamate, 58 years after saccharin was discovered (saccharin was used by Coca-Cola around 1901 to adulterate COCA-COLA® soda to lessen the need for sugar). Neither cyclamate nor saccharin were ‘obvious’ to use in cola sodas to eliminate some-to-all of the sugar, since it is 20 years before diet cola sodas are launched, NOT by Coca-Cola NOR by PepsiCo, but rather by the Kirsch brothers in 1952 (their “NO-CAL®” ginger ale) and by Royal Crown in 1961 (its DIET RITE COLA® using cyclamate and saccharin).

Terpenes. As far back as the 1980s, a tiny number of scientists started to identify some of the flavoring chemicals in cola sodas. For example, two terpenes, gamma-terpinene and limonene, were identified in 1984 in cola sodas in a paper, “Studies on turpentine-like off-odor in cola” (Journal of Food Science, March 1984). In 1991, Coca-Cola was awarded U.S. Pat. No. 5,220,105, “Process for purifying d-limonene”. In 2010, PepsiCo was awarded U.S. Pat. No. 8,431,178, “Increasing the concentration of terpene compounds in liquids”. Despite the huge size of the cola soda industry (over a hundred billion dollars a year in sales), it has not been ‘obvious’ for many ‘extraordinarily’ ‘skilled’ in whatever ‘arts’ to discuss these chemicals. In 2006, Wiley published “Terpenes—Flavors, Fragances, Pharmaca and Pheromones” by Eberhard Breitmaier, a 200-page terpene-chemistry-rich book that nowhere mentions the use of terpenes as flavorings in cola sodas. In 2003, the Royal Society of Chemistry published “A Fragrant Introduction to Terpenoid Chemistry” by Charles Sell, a 400-page terpene-chemistry-rich book, that nowhere mentions terpenes as flavorings in cola sodas. In 2006, Blackwell Publishing published “Carbonated Soft Drinks—Formulation and Manufacture” by David Steen and Philip Ashurst, a 340-page carbonated-beverage-rich book, that nowhere discusses terpene chemistry as it affects carbonated beverage (though a table of ingredients for a peach flavoring on page 67 includes terpenes such as geraniol and terpineol acetate, and a pineapple flavoring on page 83 includes “terpeneless” lemon oil). Despite mentioning GC/MS analysis, it was not ‘obvious’ in Steen/Ashurst's book to includes GC/MS analyses of the two most popular carbonated beverages in the world, Coke and Pepsi. In 2016, WileyBlackwell published “Chemistry and Technology of Soft Drinks and Fruit Juices” by the same Philip Ashurst, a 420-page carbonated-beverage-rich book. The discussion of “Flavourings” on pages 102 to 108 nowhere discussed flavoring chemicals (except the peach flavoring data from the 2006 book), and despite having five HPLC graphs of sugar content of carbonated beverages and fruit juices, it was not ‘obvious’ to have any GC/MS graphs for Coke and Pepsi focusing on known terpenes present such as gamma-terpinene and limonene. These are all failures of those ‘skilled’ in an industry with trillion of dollars of sales over the decades, and billions of dollars spent on research and development to do the ‘obvious’ with cola sodas.

Soda Terpenes as Unrecognized Hormone Disruptors

In 2018, scientists at the U.S. National Institutes of Health, led by J. Tyler Ramsey, published data confirming a link between regular exposure to externally-applied essential oils (in particular, lavender or tea tree oils) and abnormal breast growth in young boys (pre-pubertal gynecomastia). The scientists determined that at least eight chemicals in these oils probably contributed to the abnormal breast growth: eucalyptol, 4-terpineol, limonene, alpha-terpineol, linalyl acetate, linalool, alpha-terpinene and gamma-terpinene. What no one ‘skilled’ in any ‘art’ realized upon the publishing of this data, such as the FDA, is that one of the largest sources of internal exposure, for billions of people, to these potential hormone disruptors is due to their consumption of soda beverages, in particular, cola soda beverages. This complete failure of those ‘skilled’ prevents the realization that alternative flavoring formulations may be needed for soda beverages, alternative formulations that rely less on terpenes and related chemicals, if further research proves their potential as hormone disruptors on more people than just some young boys.

Coca Leaf Extracts. For over a century, the business world has speculated about Coca-Cola's use of extracts of the coca leaf. As a trade secret, Coca-Cola has steadfastly refused to publicly comment on its past use of the coca leaf, beyond the fact that the original COCA-COLA® used coca leaf extracts, and that, yes, Coca-Cola obtains its de-cocainized leaves from the Stepan Company of New Jersey, which has the only DEA license to import coca leaves from ENACO in Lima, Peru. Yet over these 100+ years, it has not occurred to anyone ‘skilled’, especially Pepsi with its billions of dollars and ‘skilled’ chemists, to spend a few dollars to call ENACO at (51) 8458-2027, and order de-cocainized coca leaf extract to be shipped to their facilities for use in their sodas. This is a complete failure of those ‘skilled’, especially for extremely competitive PepsiCo, always in second place in sales to Coca-Cola for decades. For Coca-Cola it is a manufacturing failure, but a trade-secret-war success, that is doesn't purchase de-cocainized coca leaf extract directly from ENACO, so it can maintain the fiction of secrecy created with ‘needing’ Stepan with its special DEA license, contributing to Pepsi's failure. But Coca-Cola has failed as well, despite employing ‘extraordinarily’ ‘skilled’ scientists, in one of its few technology admissions, when it admitted that it stopped using coca-leaf extracts when it launched its diet colas, and in another failure, more than likely stopped using coca leaf extracts in its sugary colas after the NEW COKE® marketing failure in 1985, a failure (even to consider) of those ‘skilled’ in recent years after news of new uses of coca leaf extract were published.

All of these failures of the ‘skilled’ to do the ‘obvious’—call ENACO to order and have shipped coca leaf extracts (their first extracts sold circa 2006), especially in the past four years, is greatly lamented by ENACO, which has struggled for decades to create new, legal markets for the coca farmers of its country. The only ‘obvious’ use of coca leaf extract in beverages seems to be as a marketing gimmick, for example, VOLT COLA® soda (produced by Ajeper S.A. of Lima, Peru), a lemony-lime soda as sugary as other sugary sodas, but with some coca leaf extract obtained from ENACO, and ginseng and guarana extracts, that contribute little to taste and do nothing to eliminate the need for sugar.

Failure to Use Ethyl benzoate. Some of the embodiments disclosed herein use an aromatic ester, ethyl benzoate (C₉H₁₀O₂, PubChem ID:7165). Ethyl benzoate is almost entirely unknown by those ‘skilled’, as a taste and/or aroma modifier for beverages and foods. The 860-page industry classic, “Source Book of Flavors” by Henry Heath (Avi Publishing, 1981), nowhere mentions ethyl benzoate. The 620-page industry classic, “Dictionary of Flavors” by Dolf De Rovira (Wiley Blackwell, 3^{rd} edition, 2017), has no entry for ethyl benzoate. The 895-page reference, “Essential Oils in Food Preservation, Flavor and Safety” edited by Victor Preedy (Academic Press, 2016), with analyses of 83 plant oils, nowhere mentions ethyl benzoate. The Standards Database of the International Fragrance Association has no entry for ethyl benzoate. Important industry references for those ‘skilled’ in the soda industry nowhere mention of ethyl benzoate, nor the coca leaf, not the terpenes, including: “Carbonated Soft Drinks: Formulation and Manufacture” by David Steen and Philip Ashurst (Blackwell, 2006); “Recent Trends in Soft Beverages” by L. Jagan Mohan Rao and K. Ramalakshmi (Woodhead Publishing, 2011); “The Soft Drinks Companion: a technical handbook for the beverage industry”, by Maurice Shachman (CRC Press, 2005); and “Formulation and Production of Carbonated Soft Drinks” by Alan Mitchell (formerly of Coca-Cola and Schweppes—Van Nostrand Reinhold, 1990). The query (SPEC/“ethyl benzoate” AND SPEC/“diet soda”) across the 10,000,000+ patents of the USPTO Patent Full Text and Image Database returns no entries, nor are there any entries returned for this query across the patent application database. The query (“ethyl benzoate” and “diet beverage/soda”) across the 28 million entries of the PubMed database returns no entries. The query (“ethyl benzoate” and “soda or beverage”) across the extensive database of the American Chemical Society returns no entries. While Coca-Cola has a patent for purifying limonene, and Pepsi has a patent for improved use of terpenes—both chemicals used by both companies in their soda beverages, neither company have similar types of patents for ethyl benzoate. This is a complete failure of those ‘skilled’ with billions of dollars for R&D in all food and beverage ‘arts’.

### SUMMARY

In one example embodiment, a diet cola beverage or syrup with an improved taste and/or aroma is disclosed that comprises ethyl benzoate, and optionally, an additional sweetener (such as glucose, and/or a 10:1 mix of cyclamate and saccharin).

In one example embodiment, a diet cola beverage with an improved taste and/or aroma is disclosed comprising a diet cola beverage product containing an extract of the coca leaf plant, and optionally, an additional sweetener. The improved diet cola beverage can also include an extract of the coca leaf where the extract of the coca leaf plant is de-cocainized, where the extract is in liquid and/or powder form. The improved diet cola beverage may also include a formulation where the diet cola beverage product and the extract of the coca leaf plans can be combined at a ratio by weight, for example, of approximately 22:1 to 44:1.

In another example embodiment, a diet cola syrup with an improved taste and/or aroma is disclosed comprising a diet cola syrup containing an extract of the coca leaf plant, and optionally, an additional sweetener. The improved diet cola syrup can also include an extract of the coca leaf where the extract of the coca leaf plant is decocainized, where the extract is in liquid and/or powder form. The improved diet cola syrup may also include a formulation where the diet cola syrup and the extract of the coca leaf plans can be combined at a ratio by weight, for example, of approximately 4:1 to 8:1.

### BRIEF DESCRIPTION OF THE DRAWINGS

FIG. 1 depicts much of the chemical composition of Coca-Cola and Diet Coke soda circa 1983.

FIG. 2 depicts a table of essential plant oils.

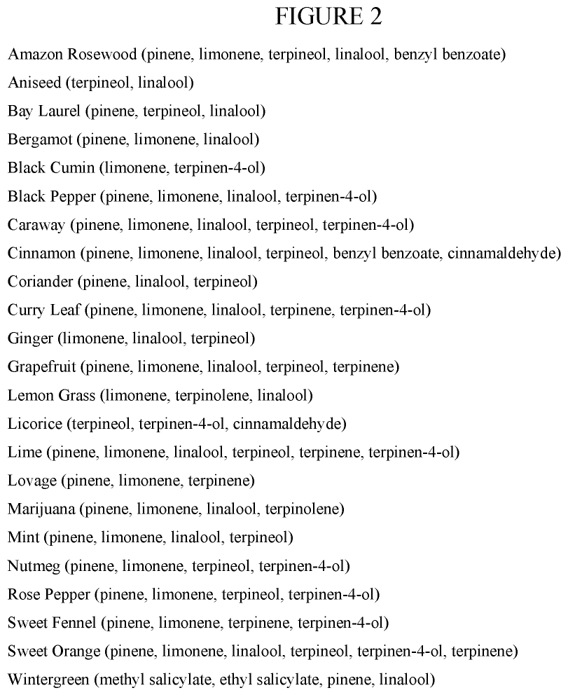

FIG. 3 is a list of flavor additives used in some food products.

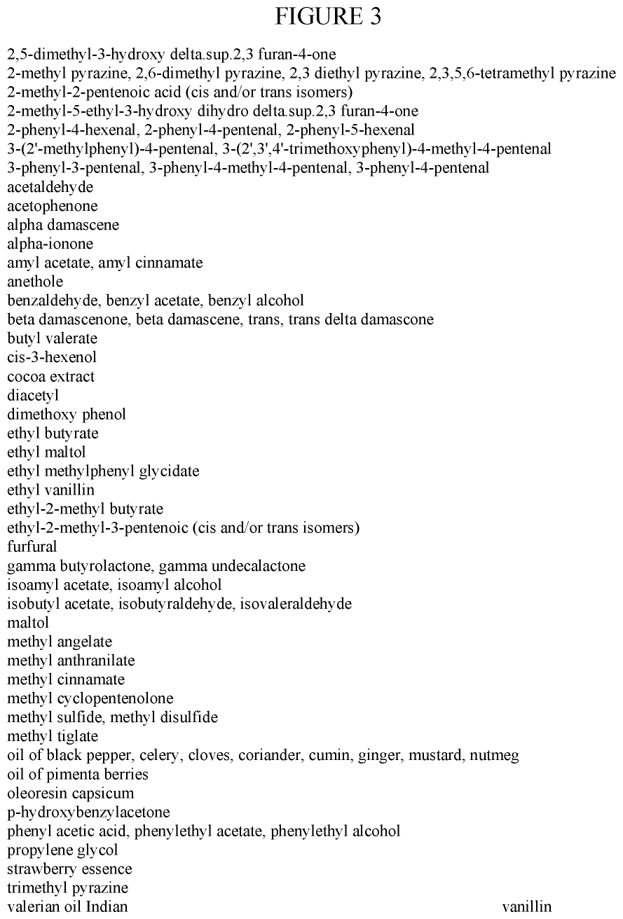

FIG. 4 depicts a GCMS analysis of ENACO ERC-A20 coca leaf liquid extract.

FIG. 5 depicts a GCMS analysis of Coca-Cola soda.

FIG. 6 depicts an alignment of a GCMS analysis of Coca-Cola soda and ENACO coca leaf extract.

FIG. 7 depicts a GCMS analysis of Diet Coke soda.

FIG. 8 depicts GCMS analyses of Coca-Cola and Diet Coke sodas.

FIG. 9 depicts GCMS analyses of Pepsi cola soda and coca leaf extract.

FIG. 10 depicts concentrations of artificial sweeteners in cola sodas.

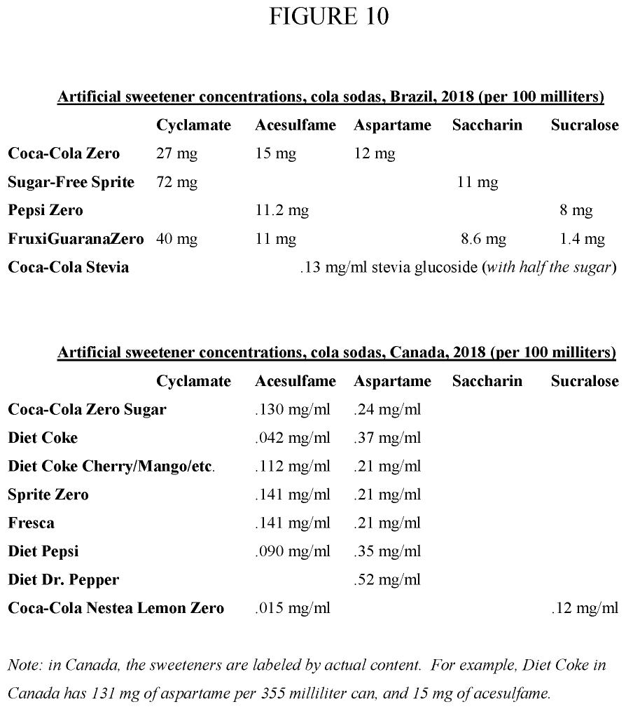

FIG. 11 depicts a formulation for a Coca-Cola flavoring.

FIG. 12 depicts a formulation for a cola aroma compound.

FIG. 13 depicts a formulation for a synthetic coca leaf extract.

### DETAILED DESCRIPTION OF ILLUSTRATIVE EMBODIMENTS

### Brief Introduction to the Embodiments Disclosed Herein

To provide enabling context for some of the embodiments disclosed herein, simple formulations are described here (with more enablement in the Exemplary Embodiments below). Pour into a cup about 7.5 ounces of a DIET COKE® that includes just aspartame. Mix in about one to two teaspoons of ENACO ERC-A20 decocainized liquid coca leaf extract, both liquids at room temperature. The resulting beverage provides a more pleasant taste and/or aroma as opposed to the taste and/or aroma that occurs solely with existing diet colas. Adding a bag of sugar (5 grams) results in an even more pleasant taste while providing a cola soda with 80% less sugar. Using glucose instead of sugar (sucrose) produce a fructose-free, low-sugar, cola soda. Using a solution of just ethyl benzoate instead of the liquid coca leaf extract also provides an improvement in taste, but lesser of an improvement than with the leaf extract.

### Terminology

For the embodiments disclosed herein, the signifier “aroma” is used in preference to its synonyms: smell and odor (which have negative connotations), and scent (which has perfume connotations). The signifier “taste” is mostly used herein, and to a lesser extent, “flavor”, which often signifies a specific “taste”. One objective test for determining an improved food product is consumer choice—e.g., in a blind taste test between two beverages, which beverage's aroma/smell/odor/scent/taste/flavor do the majority of consumers choose (“majority” reflecting that each consumer has differing aroma/smell/odor/scent/taste/flavor preferences—for example, many Colombians enjoy mondongo but not Armenian kheema), and therefore prefer to purchase in commerce.

Taste and aroma are not separate sensory experiences. For example, when many people are afflicted with the common cold, and have stuffy noses, they can lose some or all of the taste of foods. This is attributed to the odor sensors in the nose being blocked. Also, when many people eat foods, they can have a time dependent sensory experience, as the (chewed) food travels to the back of the mouth and then some of the aromas enter the back of the nasal cavity, due to retronasal smell (versus orthonasal smell due to aromas entering the front of the nasal cavity, for example, when you sniff a rose). Thus, in many of the embodiments disclosed herein, the term “taste and/or aroma” is used. Also, the Exemplary Embodiments that follows, statements in changes in taste and/or aroma are based on the opinions of a few people. Not all people drinking the embodiments disclosed herein will experience the same degree of improvement in taste and/or aroma.

As used herein, the term ‘soda’ signifies any carbonated beverage, that is, a liquid that contains bubbles of carbon dioxide. This includes ‘club soda’, that is, carbonated water with added minerals and dissolved solids; and ‘seltzer’ which is club soda minus the added minerals and dissolved solids. Both can be flavored, becoming more like the more popular sodas (or soda “pop”, a regional term in the United States, another regional term being “tonic”) with the addition of sweeteners. Carbonation levels range from 2 to 4 grams per liter for beers, around 6 grams per liter for sodas and seltzers, and around 8 grams per liter for champagne.

As used herein, the term ‘diet soda’ signifies any soda beverage that typically comprises at least one sweetener that is not a sugar (simple sugars including but not limited to, e.g., a monosaccharide or a disaccharide such as glucose, fructose, galactose, sucrose, maltose, lactose, etc.), which is intended to impart sweetness to the beverage without being metabolized as a carbohydrate. Such non-sugar sweeteners can include, but are not limited to: aspartame, acesulfame, sucralose, stevia and other non-sugar sweeteners, and/or a sugar alcohol such as xylitol or sorbitol. The use of the term ‘diet’ does not imply that the beverage has any proven properties with regards to body chemistry such as weight loss.

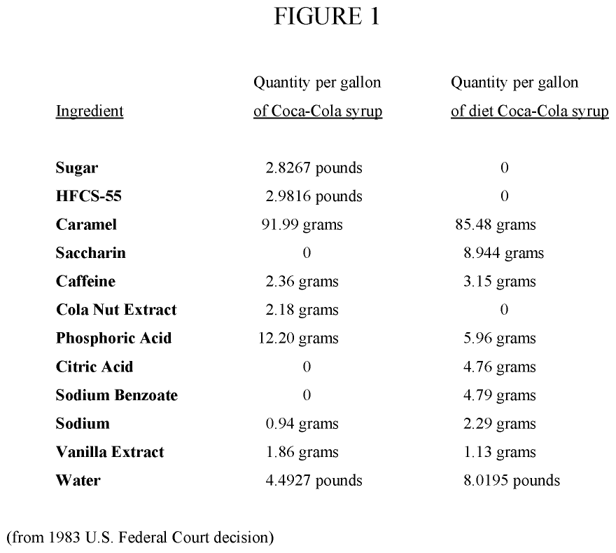

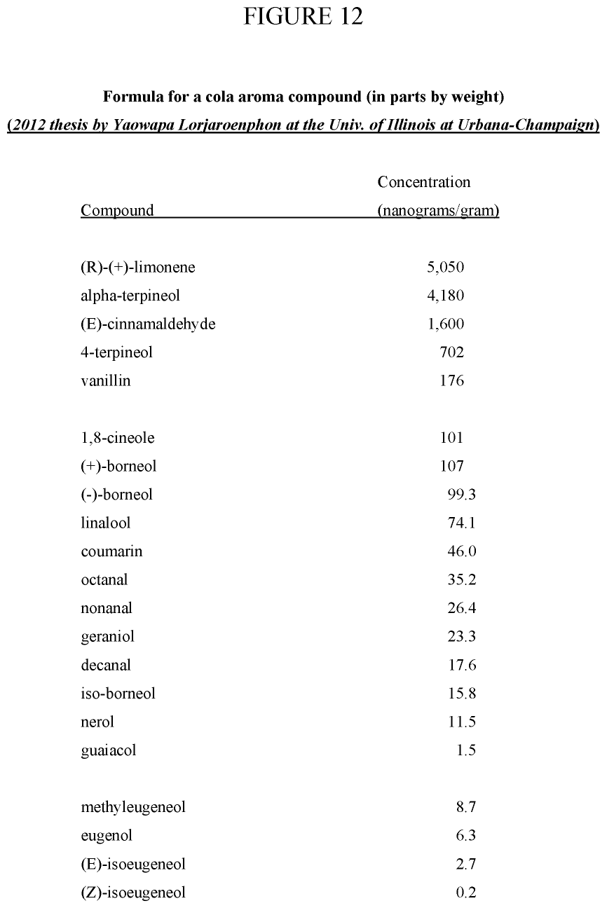

As used herein, the term ‘cola soda’ signifies any soda beverage that mostly comprises carbonated water, sweeteners (natural and/or artificial), caramel (for coloring, though not needed for a clear cola soda), phosphoric acid, vanilla flavoring (see FIG. 1 for a formulation of one brand of cola soda), and other flavorings, in particular, the “cola soda” flavoring. A variety of companies sell cola flavorings that can be used with the embodiments disclosed herein. Such flavorings include many of the chemicals listed in FIG. 12, at similar levels of concentrations. Manufacturers that sell cola flavorings include Northwestern Extracts (Germantown, Wis.); Amoretti (Oxnard, Calif.); Parker Flavors (Baltimore, Md.); Givaudan (Vernier, Switzerland); International Flavors and Fragrances (New York, N.Y.); Firmeniche (Geneva, Switzerland); Symrise (Holzminden, Germany); and Takasago (Tokyo, Japan). Similarly, the term ‘root beer’ refers to any soda beverage with much the same ingredients listed here for a cola soda, but a “root beer” flavoring is used instead of a cola soda flavoring.

Chemistry Parameters for Exemplary Embodiments

The density of DIET COKE® is approximately the same as water at 1.0 gm/ml, while COCA-COLA® soda with its many grams of sugar has a density of about 1.1 gm/ml. The density of liquid coca leaf extracts is approximately the same as the density of water, which is 1.0 gram/milliliter (gm/ml) (a cup of brewed coca tea with 250 grams of water can contain tens of milligrams of the chemicals in coca leaves—these tens of milligrams added to a few grams of water to prepare an extract do not appreciably change the density of water). In the United States, DIET COKE® essentially consists of water, caramel color, aspartame (180 mg per 350 ml), phosphoric acid (43 milligrams per 250 ml), potassium benzoate, citric acid (about 200 mg per 100 ml), caffeine (12.96 mg per 100 ml) and natural flavors. The main difference between diet cola sodas is the number and quantity of artificial sweeteners used. DIET COKE® uses one, aspartame. Most of the others use two or three selected from aspartame, acesulfame or sucralose, though some also use stevia.

For the exemplary embodiments that follow, the examples are performed with all liquids at room temperature. Sodas typically taste more pleasant at lower temperatures (sodas retain carbonation better at lower temperatures, which creates a better taste for many people). Any improvements in taste and/or aroma resulting from any of the following embodiments at room temperature are similar, if not more pleasant, at lower temperatures down to freezing. Tastes and/or aromas can also vary due to the use of soda container: glass, plastic, metal or paper. There are many who think that cola sodas taste best when consumed from glass bottles. For many of the exemplary embodiments disclosed herein, Bodum PAVINA® Coffee Mugs, double-wall insulated glass mugs, 8-ounce size, are used.

While DIET COKE® in the U.S. with one artificial sweetener is used in many of the following examples that disclose how to improve the taste and/or aroma of diet colas, the embodiments are useful, e.g., for improving any other diet cola soda or diet root beer or diet soda (typically with multiple artificial sweeteners), or to improve non-Coca-Cola cola sodas to have their tastes and/or aromas provide an experience more like that of Coca-Cola sodas.

Many of the Exemplary Embodiments disclosed herein use, solely for purposes of illustration, about 5 grams to about 10 grams of liquid coca leaf extracts (about 1 to about 2 teaspoons) and about 220 grams of a beverage such as diet cola. Such quantities can be scaled to any degree for purposes of manufacturing and distribution. For example, about 5 gallons to about 10 gallons of extracts can be added to about 220 gallons of a beverage. Also, where about 2.5 grams to about 10 grams of extract are added to about 220 grams of beverage, lesser amounts of extract can be added, for example, about 1 nanogram to about 1000 nanograms, about 1 milligram to about 1000 milligrams, about 1 microgram to about 1000 micrograms, or about 1 gram to about 10 grams, that is, any quantity of extract to adjust the beverages for taste preferences. Similar ranges also apply when using a synthetic extract. Also, where about 5 grams to about 10 grams of a sweetener (such as sugar, xylitol, or an artificial sweetener) are used in any of the embodiments disclosed herein, lesser amounts of the sweetener can be added, for example, about 1-1000 nanograms, about 1-1000 milligrams, about 1-1000 micrograms, or about 1-10 grams, that is, any quantity of extract. Where quantities above about 5 grams to about 10 grams per about 220 grams of beverage are used below, for example about 20 grams, intermediate quantities such as 17 grams can be used.

### Exemplary Embodiment #1

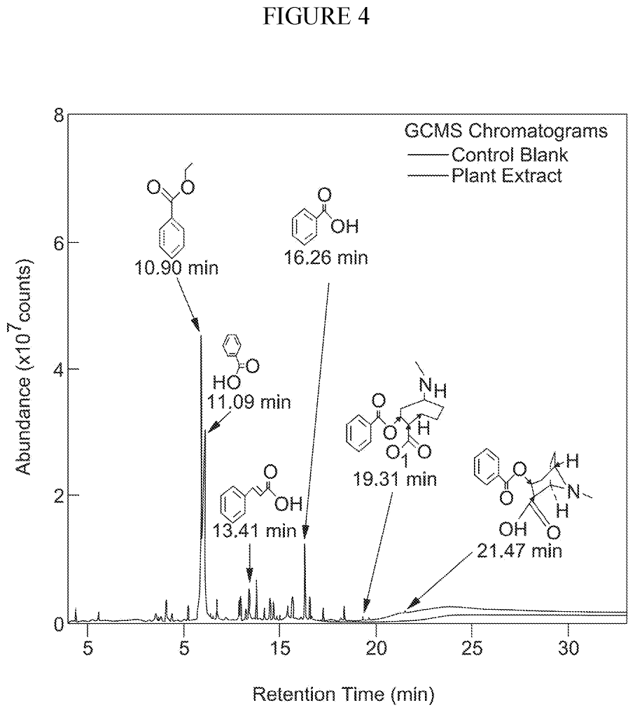

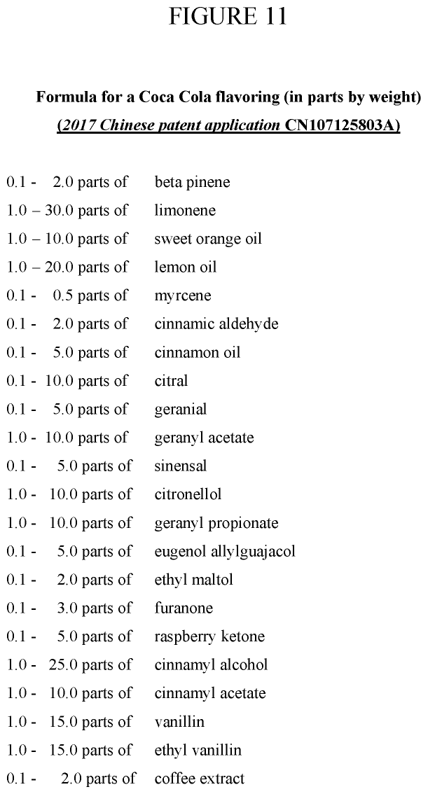

One embodiment of an improved cola beverage product is understood with the following exemplary method and resulting exemplary article of manufacture. Pour about 7.5 ounces of DIET COKE® (about 220 grams—about 222 milliliters) into a container such as a cup. Mix in about one half teaspoon to two teaspoons (about 2.5 to 10 grams—about 2.5 to 10 milliliters) of coca leaf extract, for example, the ERC-A20 liquid coca extract available from ENACO (Lima, Peru) or its equivalents. The resulting beverage, when consumed, is more pleasant than existing diet colas. Any coca leaf extract with similar chemical components (see FIG. 4 and FIG. 11, for example) to ERC-A20 (the version of the extract circa 2018/2019) can be used, and the extracts can be added to other diet sodas such as COKE ZERO® and COKE ZERO SUGAR®.

Adding more than two teaspoons of coca leaf extract does not significantly improve the “Coca-Cola” taste and/or aroma for many people, and can make the resulting beverage have more of a leafy taste and/or aroma. The number of teaspoons of coca leaf extract added per 222 milliliters (and similar ratios for larger quantities) can be chosen to satisfy consumer preferences, for example, to create a more “coca leaf tasting” cola soda as a new product line. The current formulation of ERC-A20 liquid coca leaf extract has a bit of an oil base, which can impart an “oily” taste. This “oily” taste can be minimized, by increasing the concentration of the coca leaf extract in the oil base, e.g., by a factor of four to five, or by using an oil-free synthetic extract (e.g., to be added to syrup emulsions). Then, where one to two teaspoons are used in some of the Exemplary Embodiments disclosed herein, less than a half teaspoon of concentrated extract can be added.

This example illustrates one exemplary ratio of diet cola soda to coca leaf extract, that of approximately 22:1 (220 grams/10.0 grams) to approximately 44:1 (220 grams/5.0 grams). Any ratio between 22:1 and 44:1 can be used to achieve a similar improvement. The ratio depends entirely on the final taste desired by the manufacturer of the diet cola soda. A lesser amount of coca leaf extract, i.e., ratios greater than 44:1, can be used, but will have less of an improvement in the “Coca-Cola” taste. A greater amount of coca leaf extract, i.e., ratios less than 22:1, can be used, if a soda is desired with a greater taste of the coca leaf extract.

Although the formulation in this embodiment describes the use of fluid extract of coca leaves, similar results can be obtained using a powdered form of an extract of coca leaves. In a variant of Exemplary Embodiment #1, about two grams of powdered ERC-ARC extract is used instead of 1.5 teaspoons of the liquid extract. An improvement in taste and/or results. For all of the Exemplary Embodiments disclosed herein, wherever about 1.5 teaspoons of liquid ENACO coca leaf extract is used, about two grams of powdered ENACO coca leaf extract can be substituted (or equivalent coca leaf extracts), though other amounts of powdered extract can be used depending on the final beverage taste desired.

### Exemplary Embodiment #2

Another embodiment of an improved diet cola beverage product mixes ERC-A20 coca leaf extract with a diet cola syrup. Typically, about 1 part of cola syrup is mixed with about five parts of soda water. If one mixes 240 milliliters of cola soda beverage with 5 grams (one teaspoon) of ERC-A20 coca leaf extract, then one can mix 40 grams of cola syrup with 5 grams of the extract, a ratio of 8:1, to which soda water is later added. If a five-times concentrated version of coca leaf extract is available, then 1 gram of extract can be mixed with the 40 grams of cola syrup. Again, more or less extract can be added to the syrup, depending on the desired final taste. Some suppliers of cola syrup include the following companies: Coca-Cola, PepsiCo, Sodastream (acquired by PepsiCo in 2018), Carnival King (their syrup is used for making cola slush), and RC Cola.

### Exemplary Embodiment #3

Another embodiment of an improved diet cola beverage product mixes ERC-A20 coca leaf extract with DIET PEPSI® soda (with similar ratio adjustments for Diet Pepsi syrup). Many perceive DIET PEPSI® to be “sweeter” than DIET COKE®, with less of an aftertaste to many. Despite this apparent consumer taste preference, DIET COKE® has higher sales volume (maybe being sweeter is less of a consumer preference than having more ‘coca cola’ taste). While a DIET COKE® with an improved taste and/or aroma can be prepared by mixing 220 grams of DIET COKE® with about one teaspoon of coca leaf extract, a DIET PEPSI® with an improved taste and/or aroma can be prepared by mixing 220 grams of DIET PEPSI® with 0.5 (one-half) teaspoon of coca leaf extract. Another embodiment comprises 220 grams of a less-sweet DIET PEPSI® soda and about one-half to one teaspoon of ERC-A20 coca leaf extract, though other amounts of extract can be used depending on the final beverage taste desired.

### Exemplary Embodiment #4

For some of the embodiments disclosed herein, mixtures of coca leaf extracts and diet soda beverages (and their syrups), of which their sugary versions have a ‘plant-ish’ taste (e.g., root beer) or ‘cough-syrupy’ taste (DR. PEPPER®), are prepared with any of a variety of formulations of such diet soda beverages of the type available circa the year 2017, such as DIET A&W ROOT BEER®, IBC DIET ROOT BEER® and DR. PEPPER®. To some people, diet root beers and diet DR. PEPPER® taste ‘less unpleasant’ than diet colas, as compared to their sugary versions, due in part that to many people, root beer soda and DR. PEPPER® already taste a bit ‘weird’.

One such embodiment comprises mixing 240 milliliters of diet root beer soda with about 0.5 (one-half) teaspoon of ERC-A20 coca leaf extract, that is, mixing approximately half as much coca leaf extract with a diet root beer soda, as opposed to about one or more teaspoons of coca leaf extract to a diet cola soda. Less of an improvement in taste and/or aroma is experienced with the root beer/coca extract mixture. More or less than 0.5 teaspoon can be added, depending on the final beverage taste desired.

Sodium Cyclamate and Other Artificial Sweeteners

Other embodiments disclosed herein can comprise any of these diet beverages (and their syrups) where artificial sweeteners such aspartame and acesulfame are replaced or augmented by other artificial sweeteners, for example, combinations of sodium cyclamate (C₆H₁₂NNaO₃S), and saccharin (C₇H₅NO₃S). For example, a combination of approximately 10 parts of sodium cyclamate and 1 part of saccharin, a combination which is known to mask the most of the aftertastes of the two artificial sweeteners, can be used instead of aspartame or acesulfame. In other embodiments, one can use the formulas of Exemplary Embodiments #1 and #2, but replace the aspartame in the DIET COKE® sodas and syrups with at least double the amount (in terms of sweetness) of about a 10:1 combination of cyclamate:saccharin (40 to 50 milligrams of aspartame is about as sweet as 80 to 100 milligrams of a cyclamate:saccharin combination, both of which have about the same sweetness as 8 grams of sugar). Ratios other than 10:1 can be used for the combination of cyclamate and saccharin—about a 10:1 ratio is known to have the least unpleasant taste.

In other embodiments, to obtain more texture in a diet soda beverage, pectin (such as Herbsteith & Fox' Pectin Combi Plus 210) can be added along with the cyclamate and saccharin (or can be added along with other sweeteners used in embodiments disclosed herein).

In some embodiments disclosed herein, diet root beers with added coca leaf extract can have artificial sweetener added (or an alternative to an existing artificial sweetener) using a combination or sodium cyclamate and saccharin. Extracts of coca leaf are compatible with food products that can use sodium cyclamate and saccharin as an alternative or complementary artificial sweetener. Since little additional sweetener needs to be added, another family of sweeteners, sugar alcohols such as xylitol, can be used.

### Exemplary Embodiment #5

Another embodiment disclosed herein comprises 220 milliliters of DIET COKE®, one teaspoon of ERC-A20 coca leaf extract, and up to about one bag of mostly sugar-free SUGAR TWIN® artificial sweetener (one bag weighs about 0.8 grams—a bit less than a quarter of a teaspoon, produced by B&G Foods North America, and is 32% by weight sodium cyclamate, the rest being d-glucose [i.e, sugar] and silicon dioxide [i.e., sand]) or its equivalents. The resulting beverage is quite sweet while only requiring about 0.4 grams of sugar, as opposed to the 40 or so grams in sugary sodas—a 99% reduction. A pleasant but less sweet beverage is obtained by only adding an eighth of a teaspoon of the SUGAR TWIN®. Alternatively, one bag of mostly sugar-free, stevia-based NEVELLA® sweetener from Heartland Food Products (one bag weighs 1.0 grams, produced, which is 3% by weight of stevia extract, the rest being d-glucose). Alternatively, a few drops of a pure stevia extract, such as NATUVIA® (a combination of water, stevia extract, sodium benzoate, potassium sorbate, and malic acid) can be added, though purer stevia extracts tend to have an unpleasant taste and detract somewhat from the increased pleasantness due to the coca leaf extract, unless the extracts have more, or consist entirely of, rebaudioside A, which is the least unpleasant and has less after taste than the other glycosides in the stevia leaves. When granular artificial sweeteners are mixed into a carbonated beverage, it can foam due to nucleation, causing a loss of some carbon dioxide. To compensate, soda or syrup can be manufactured with higher levels of carbon dioxide before powdered sodium cyclamate is added, or a liquid solution, with sodium cyclamate dissolved, can be added to the syrup. In some taste tests, ERC-A20 coca leaf extracts and/or sodium cyclamate added to DIET COKE® (a total of 2 artificial sweeteners) has a taste and/or aroma more preferred than that of coca leaf extracts and/or sodium cyclamate added to COCA-COLA ZERO® (with 3 artificial sweeteners).

### Exemplary Embodiment #6

Another exemplary embodiment of the inventions disclosed herein comprises 220 milliliters of DIET COKE®, and up to about one bag of mostly sugar-free SUGAR TWIN® artificial sweetener (one bag weighs 0.8 grams, produced by B&G Foods North America, and is 32% by weight sodium cyclamate—about 250 milligrams, the rest being dextrose and silicon dioxide)—that is, no coca leaf extract is used. This only produces a sweeter DIET COKE® with an overall taste and aroma similar to that of other multiple-sweetener diet colas such as DIET PEPSI®.

### Exemplary Embodiment #7

To the combination of DIET COKE®, coca leaf extract and SUGAR TWIN® as disclosed in Exemplary Embodiment #5, three drops of liquid SWEET'NLOW® are added (manufactured by Cumberland Packing), which only has the artificial sweetener saccharin. While this makes the resulting beverage a bit sweeter, the use of saccharin also reduces some of the lingering unpleasant aftertaste experienced due to the other artificial sweeteners present. An artificial sweetener from Brazil, ZERO-CAL® (produced by Cosmed Indústria de Cosméticos e Medicamentos in Goiânia) is a mix of sodium cyclamate and sodium saccharin (ratio not on the label), and sorbitol (one of the sugar alcohols, being about 60% as sweet as sucrose). It has little of the unpleasant taste associated with artificial sweeteners, while its taste can linger for less time. ZERO-CAL® and its equivalents can be used in the embodiments disclosed herein. A product similar to ZERO-CAL®, which can be used with the embodiments disclosed herein, is DUL-SUC® (produced by Prater Laboratorios of Santiago, Chile), which is a mix of cyclamate and saccharin. One milliliter of DUL-SUC® contains 35.3 milligrams of sodium saccharin, and 119.2 milligrams of sodium cyclamate. 5 drops (“gotas”), equal to 0.2 milliliters with about 7 milligrams of saccharin and 24 milligrams of cyclamate, provides sweetness equal to one teaspoon of sugar.

Exemplary Embodiment #7 is the basis of embodiments of other improved diet cola sodas, as follows. Prepare a cola beverage or syrup that has no sweeteners. Then add coca leaf extracts according to many of the embodiments disclosed herein. Then add an artificial sweetener that has about a 10:1 ratio of cyclamate/saccharin (with or without a low amount of a sugar alcohol, for example, a variant of the Brazilian ZERO-CAL® which has a about a 10:1 ratio of cyclamate/saccharin), adding more of this artificial sweetener than is disclosed used in Exemplary Embodiment #7, to achieve similar levels of sweetness to products such as DIET COKE® while eliminating one source of unpleasant taste (such as aspartame).

### Exemplary Embodiment #8

In embodiments that use SUGAR TWIN® or its equivalents, up to about one bag of SWEETWELL® artificial sweetener can be used instead. SWEETWELL® is a combination of polydextrose (a glucose polymer), isomalt (a sugar alcohol), dextrin, inulin (a collection of fructose polymers), fructooligosaccharide (derived from inulin) and sucralose. In other embodiments, a gram or so of xylitol (or other sugar alcohol) can be used.

### Exemplary Embodiment #9

Another embodiment disclosed herein comprises 220 milliliters of DIET COKE® (minus any artificial sweetener), plus about one teaspoon of ERC-A20 coca leaf extract, and up to 3 grams of a combination of approximately 10 parts of sodium cyclamate and 1 part of saccharin (or combinations of other artificial sweeteners such as xylitol, sorbitol, maltitol and/or erythritol), and/or with some sugar.

### Exemplary Embodiment #10

Around the world, many companies sell their versions of cola sodas with a similar taste and/or aroma to COCA-COLA®, all attempting to recreate the COCA-COLA® soda, but none doing so exactly. One of the closest-tasting cola sodas is PEPSI®, which many consumers experience as being sweeter than COCA-COLA®, maybe due to overcompensation for its lesser “cola” taste (335 milliliters of PEPSI® has 41 grams of sugar, while 335 milliliters of COCA-COLA® has 39 grams of sugar). Another embodiment is where a company such as PepsiCo produces a new cola, where the amount of sugar in their existing products are decreased and some coca leaf extract added, for example, using less than a half-teaspoon of extract with 220 milliliters of a non-COCA-COLA® soda, and less than 25 grams of sugar.

### Exemplary Embodiment #11

Low Sugar Sodas. In some embodiments disclosed herein, low sugar sodas are made by adding both a small amount of sugar, and coca leaf extract, to the diet sodas. For example, one or a few 3.5-to-5 grams bags of sugar can be added with the leaf extract to DIET COKE® (versus 25 to 39 grams in cans of COCA-COLA®).

Another embodiment of the inventions disclosed herein comprises 220 milliliters of DIET COKE®, about one teaspoon of coca leaf extract, and one bag (about 5 grams) of sugar. The result is a more pleasant tasting DIET COKE® soda. This embodiment is of great use in commerce in that in the past, cola soda companies have (unsuccessfully) marketed what are basically 50%-of-the-sugar cola sodas, such as COCA-COLA C2® (half the sugar, about 20 grams, and three artificial sweeteners) or COCA-COLA LIFE® and PEPSI TRUE® (half the sugar, plus stevia), the consumer apathy due in part to a 50% reduction in sugar being of little health value where the taste is still unpleasant. But with this embodiment, cola sodas with about, and more than, an 80% reduction in sugar can be manufactured, since this embodiment uses only 5 grams of sugar while 220 milliliters of sugary COCA-COLA® uses about 23 grams of sugar, thus achieving a 78% reduction in sugar. A reduction in sugar by over 90% is achieved by using less sugar, and some additional artificial sweetener as enabled in Exemplary Embodiment #5. In another embodiment, instead of using about 5 grams of sugar, instead, about 6 grams of glucose is used to achieve a similar increase in sweetness. The advantage of using glucose is that it introduces no fructose into the soda beverage (sugar is a disaccharide that is 50% glucose and 50% fructose), a great health benefit since excessive fructose consumption is linked to a variety of diseases including non-alcoholic fatty liver disease.

The sugar alcohol, xylitol is popular as a sugar substitute in the food industry, in small amounts, because it is a 1:1 replacement for sugar by weight and sweetness, has a low glycemic index, and is not converted into acids that cause tooth decay. As safe amounts of xylitol for both adults and children are less than 20 grams a day, using five grams of xylitol in place of five grams of sugar allows for the daily consumption of four cans of cola sodas using some of the embodiments disclosed herein. For example, one teaspoon of powdered xylitol was added to 1.5 teaspoons of ERC-A20 liquid coca leaf extract. After fully dissolving, the mixture was added to 220 milliliters of DIET COKE®. An improvement in taste is experienced upon consuming. Other sugar alcohols can be used.

Glycyrrhizin is a natural sweetener that is 30 to 50 times sweeter than sugar, and has a zero glycemic index, but is a strong contributor of the licorice taste. In yet another embodiment, a diet “licorice-cola” can be manufactured using glycyrrhizin as a sweetener in replacement for, or along with, other sweeteners used in the embodiments disclosed herein.

Non-degradation of Added Coca Leaf Extract

One-half tablespoon of ENACO ERC-A20 extract was added to plastic bottles containing 355 milliliters of DIET COKE®, and gently mixed, and then stored at room temperature. Soda in these bottles were sampled at 30, 60, 90 and 120 days, and there was little noticeable difference in taste and aroma. In all cases, there is no noticeable difference in the coloring of the DIET COKE®, nor is any clouding or sedimentation observed. Thus, the commercial use of coca leaf extract in cola sodas does not negatively affect the tastes and aromas of the improved sodas by being in the acidic environment of bottled sodas for the typical short-to-long term time periods experienced by bottled sodas stored on shelves at retail establishments.

Additional Flavorings

All of these embodiments can further comprise additional flavorings to create drinks with similarly pleasant tastes and aromas. Two additional flavorings, in small amounts, are vanilla and cinnamon. In the above embodiments, quantities of vanilla and/or cinnamon of approximately less than 1/128th (one one-hundred-twenty-eighth) of a teaspoon can be added to mixtures of diet colas and coca leaf extracts without interfering with the “cola” taste and aroma.

Coca Extract Chemistry

In some exemplary embodiments, the coca leaf extract is derived from at least one member of the plant genus Erythroxylum (“E.”). In some embodiments, the coca leaf extract is derived from at least one member selected from the group comprising E. coca (much grown in Bolivia and Peru), E. novogranatense var. truxillense (Trujillo, much grown in Peru, bought by Coca-Cola), and E. novogranatense var. novogranatense (much grown in Colombia). The E. coca and E. novogranatense are traditional sources for coca teas consumed in South America, but other coca varieties can be used as well whose extracts have similar chemical compositions to the extracts discussed and analyzed in the examples below, varieties such as E. citrifolium, E. havanese, E. raimondii and E. rotundifolium. For such varieties that don't have benzoylmethylecgonine and ecgonine present in the leaves, such varieties can be grown and have extracts prepared in countries such as the United States, China and Armenia.

Coca leaves, similar to grapes and tomatoes and other food sources, have a variety of tastes depending on the variety of coca plant and their soil conditions. For example, pleasant tasting coca teas can be manufactured with leaves from the Cauca and Valle de Cauca regions of Colombia; the Cuzco, Ayacucho and Trujillo regions of Peru, and the Yungas region of Bolivia. Manufacturers of the embodiments disclosed herein can choose one or more varieties of coca leaf to use in preparing extract, depending on the consumer preferences for the taste of the embodiments (for example, a diet cola with more or less of a “coca” taste). Chemicals in the extracts can also be obtained by brewing coca leaves in hot or cold water, and removing much of the water; or the coca leaves can be added to soda syrup for extended periods of time and then removed.

Coca tea has been safely consumed for over 500 years in South America (LD50 of coca tea is 3450 mg/kg—safer than vanilla and table salt). By U.S. law (21 C.F.R. 182.20), decocainized coca leaves, and their extracts, are “Generally Recognized As Safe” for use in food products. By law (U.S. 21 C.F.R. 172.515), the FDA has approved the following chemicals, found in some coca leaf extracts, for individual use in food products: ethyl benzoate, cinnamic acid, and ethyl cinnamate. None of these chemicals are listed in the ingredient table published by Coca-Cola (see: http://www.coca-colaproductfacts.com/en/coca-cola-ingredients/#glossary-C).

For some of the embodiments disclosed herein, a commercially-available liquid coca leaf extract, ERC-A20 (circa 2018, and any later equivalent), is used which does not directly exploit the genetic resources of the coca plant. ERC-A20 is manufactured and distributed by ENACO (Empresa Nacional de la Coca S.A., www.enaco.com.pe), the Peruvian government agency responsible for the industrialization of coca leaf products in the country. The extract is available in liquid form (e.g. a one-kilogram bottle of the liquid ERC-A20 extract), and in powdered form which can also be used in the products and methods disclosed herein (ENACO sells a powdered product, “Mate de Coca Instantaneo” with two grams of powder per packet/sachet). Adding about one such packet to one cup of hot water creates a similar color/taste/odor to adding two teaspoons of the liquid extract to one cup of hot water. Equivalents of the extract also can be made by removing the water from coca tea brews, with (un)desired alkaloids removed via ion-exchange filters.

Typically, ENACO uses coca leaves from different regions of Peru that are picked and dried in the field, before being shipped to Lima. The embodiments disclosed herein use the ERC-A20 liquid extract circa 2018/2019, which is derived mostly from coca leaves from the Cusco region of Peru (about 70%) and from the Ayacucho and Trujillo regions of Peru (about 30%). A mixture of coca leaves from other parts of Peru and South America (e.g., the Los Yungas region of Bolivia, the south of Colombia), with different combinations of leaves, can be used in the embodiments disclosed herein if they have a similar chemical profile as does ERC-A20, with chemicals added to compensate for any differences, if needed. The leaves are bagged at ENACO facilities in Lima, and a container of coca leaf bags loaded for shipment from Callao (the port of Lima) to the United States. A typical bag of coca weighs about 0.8 grams. About 17 average-sized dried coca leaves weigh about 1.0 gram. Thus, a typical bag of coca tea can contain about 13 to 14 leaves (depending on the sizes of the leaves). In Bolivia, a 50-pound bag of dried coca leaves is referred to as a ‘taqui’ and can cost about US $200. In Colombia, a 12.5-kilogram bag of dried coca leaves is referred to as an ‘arroba’, and can cost, circa 2018, US $15.

FIGS. 4 to 9 are gas chromatographic—mass spectrometry (GCMS) analyses of coca leaf extract and cola sodas. All of the samples were analyzed using an Agilent 7890B gas chromatograph. Data acquisition was accomplished using MassHunter software. Sample peaks were compared with about 800,000 reference compounds using the NIST/EPA/NIH mass spectral search program. The ionization mode for the GCMC analysis used was electron impact. The initial temperature of samples was 50° C., and the final temperature was 320° C. The detector temperature was at 310° C.

FIG. 4 is a GCMS analysis of the liquid form of the ERC-A20 coca leaf extract. One milliliter of ERC-A20 was mixed with one milliliter of dicholoromethane (DCM), with the DCM layer injected into the GCMS system for analysis. The main peaks, some identified by their retention times (RT), are as follows: 10.90—ethyl benzoate (an ester with a fruity aroma used in perfumes); 10.89 and 11.09—benzoic acid and an isomer; 12.90 and 12.99—trans-cinnamic acid (has a honey-like aroma found in cinnamon oil) and ethyl cinnamate (an ester with a fruity aroma found in cinnamon oil); 13.41—an isomer of trans-cinnamic acid; 13.795—an isomer of ethyl cinnamate; 14.799—ethyl vanillate; and 16.26—isomer of 3,4,5-trimethoxybenzoic acid (also known as eudesmic acid, found in olive oil and eucalyptus oil). Any variety of coca leaf that has similar amounts of these chemicals can be used to prepare extracts that can be used wherever the ERC-A20 extract is used in the exemplary embodiments disclosed herein. Conversely, varieties of coca leaves known to be less pleasant to drink (such as the coca leaves from the Chapare region of Bolivia) or to have a weaker taste (such as the coca leaves from parts of Colombia) and thus less useful in the embodiments disclosed herein, can have their extracts augmented with these chemicals to make them more useful in the embodiments disclosed herein. For example, the Erythroxylum pungens specie of coca leaves found in Brazil is reported to have anti-cancer properties. Extracts of this specie can be augmented with ethyl benzoate and other chemicals found in the ERC-A20 extract, and used in the embodiments disclosed herein.

In some embodiments disclosed herein, the coca leaf extract can comprise one or more chemicals that can be found in coca leaves, selected from the group comprising: ethyl benzoate, benzoic acid, trans-cinnamic acid, ethyl cinnamate (and cinnamon-family chemicals with similar tastes and aromas such as cinnamaldehyde), and ethyl vanillate. Coca leaf extracts with coca alkaloids (prohibited by law in some countries) can be used in the embodiments disclosed herein that use de-cocainized coca leaf extracts or their equivalents, while achieving similar improvements in taste.

In some embodiments, the coca leaf extract can comprise one or more of the chemicals which were detected in smaller quantities in the GCMS analysis of FIG. 4: benzoyl alcohol, caffeic acid dimethyl ester, ethyl benzoate, ethyl phenylacetate, ethyl vanillate, hexanoic acid, hexenoic acid, isovaleric acid (also known as 3-methylbutanoic acid), maltol, and vanillin. In some embodiments, the coca leaf extracts can comprise one or more of other chemicals reported to be present in coca leaves, tea brews and extracts, which include: dihydrocuscohygrine, hydroxytropacocaine, tropacocaine, methyl benzoate, methyl cinnamate, cinnamic acid, truxilline, and truxillic acid.

While coca leaf extracts can be used as a natural source of one or more of these chemicals (and/or their analogs), the equivalents of coca leaf extracts can also be prepared from synthetic sources for the above, and related, chemicals. For example, a foundation for a synthetic extract can be a combination of any of the chemicals of the main peaks of FIG. 4: ethyl benzoate, benzoic acid, trans-cinnamic acid, ethyl cinnamate, ethyl vanillate, and eudesmic acid. Such a synthetic extract can additionally comprise chemicals with similar taste and aroma properties. For example, cinnamaldehyde can supplement, or be an alternative, to ethyl cinnamate. One possible synthetic extract is disclosed in Exemplary Embodiment #13.

Headspace Gas Chromatography Mass Spectrometry (HGCMS)

A one milliliter sample of liquid ERC-A20 coca leaf extract was sealed in a 20 milliliter headspace sampling vial, and incubated at 100 degrees Centigrade for 10 minutes prior to injection of the headspace gases. For HGCMS, approximately 1 milliliter of the headspace gases present were transferred to the GCMS system for analysis. The compounds detected in the HGCMS analysis of the coca leaf extract include ethyl acetate, 3-methylbutanol (isoamyl alcohol), 3-methylbutanal (isovaleraldehyde) eucalyptol and trimethyl oxazole, any of which can be added to synthetic coca leaf extracts as disclosed herein.

Using Extracts of the Entire Coca Leaf

In countries where coca tea is not allowed by law to be sold at retail businesses, due to the presence of two coca alkaloids, benozylmethylecgonine and ecgonine, de-cocainized coca leaf extracts are used in some of the embodiments disclosed herein (and can be used anywhere in the world where COCA-COLA® soda can be sold by law). In addition, for countries such as Colombia, Peru and Bolivia, where coca tea is sold in retail establishments (or in countries such as Spain and Portugal, which have decriminalized all drugs, and thus can be amenable to products such as coca tea), coca leaf extracts with at least these two coca alkaloids can be used with the embodiments of diet sodas disclosed herein.

Additional Exemplary Disclosure

Mixtures of coca leaf extract and diet sodas can also be achieved by an infusion process to prepare the extract, for example, placing one bag of coca tea in 7.5 ounces of diet soda, and removing the bag after 30 minutes to a few hours or more (coca tea is typically brewed in hot water for 3 to 5 minutes). Equivalently, one can dehydrate a cup of coca tea, and then add the resulting coca tea extract powder to the 7.5 ounces of diet cola. A bag of coca tea can have the equivalent of ten coca leaves, and approximately 17 coca leaves can weigh about one gram.

Concentrations of Chemical Components of Cola Sodas

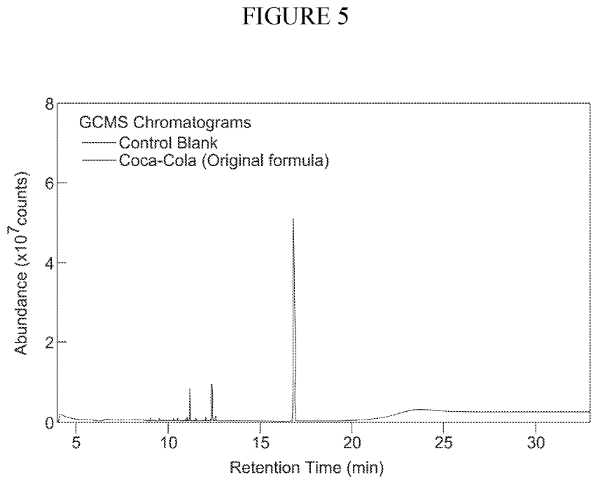

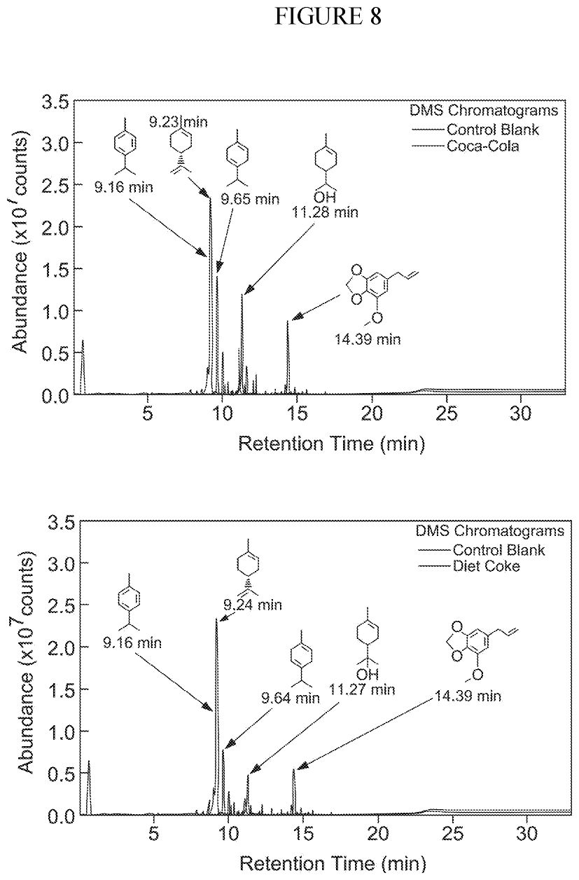

FIG. 5 depicts the results of a GCMS analysis of COCA-COLA® soda. The peak at a retention time of 16.86 is caffeine, the peak at retention time of 12.39 is probably a combination of terpin and terpine-4-ol, and the peak at retention time of 11.21 is alpha-terpineol. FIG. 8 depicts the results of desorption gas chromatography mass spectrometry of COCA-COLA® and DIET COKE® sodas, using Stir Bar Sorptive Extraction. The peak at retention time 9.16 corresponds to cymene, the peak at 9.23/9.24 corresponds to limonene, the peak at 9.64/9.65 corresponds to gamma-terpinene, the peak at 11.27/11.28 corresponds to alpha-terpineol and the peak at 14.39 most likely corresponds to myristicin.

In the laboratory report in which FIG. 4 first appeared, it is reported that the chemicals detected in “abundance” in the coca-leaf extract are: ethyl benzoate, benzoic acid and its ester; and 3,4,5-trimethoxybenzoic acid (eudesmic acid). Chemicals detected in “lower abundance”: compounds consistent with: ethyl cinnamate, and trans-cinnamic acid and its isomer.

In the laboratory report in which FIG. 5 first appeared, it is reported that the chemicals detected in “abundance” in the sample of COCA-COLA® are: caffeine, terpin, terpine-4-ol, alpha-terpineol. Chemicals detected in “lower abundance”: compounds consistent with o-cymene, cinnamaldehyde, and fenchol. Cymene and alpha-terpineol are also seen in FIG. 8, along with limonene, gamma terpinene and myristicin.

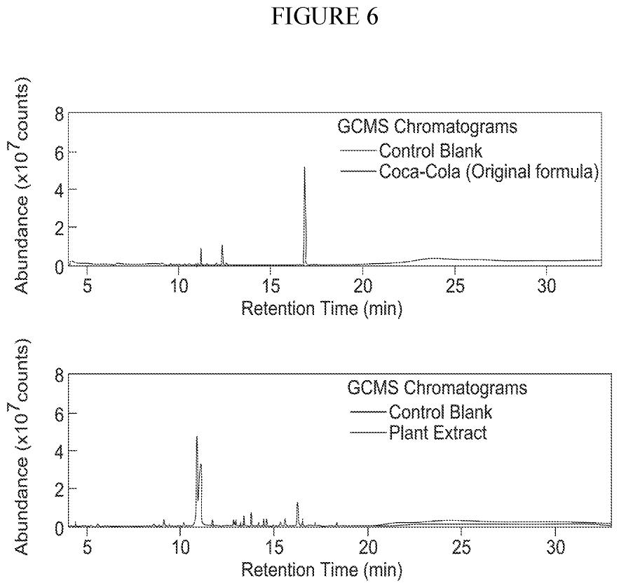

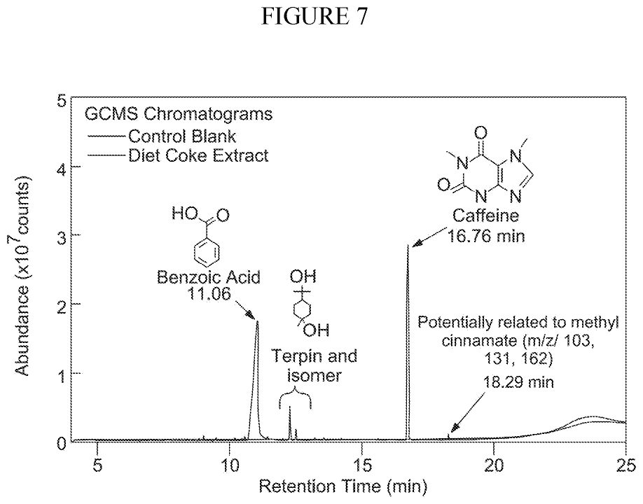

The lack of overlap of the main peaks of FIG. 5 (and FIG. 7) with the main peaks of FIG. 4 (a GCMS analysis of coca leaf extract—see comparison of FIGS. 4 and 5 in FIG. 6), indicates that Coca-Cola is not using extracts of the coca leaf in its cola sodas, at least, Coca-Cola is not using extracts of coca leaves of the variety used by ENACO to produce its ERC-A20 extract, even though Coca-Cola's supplier of de-cocainized coca leaves, the Stepan Company, buys all its leaves from ENACO. Pepsi has never made use of extracts of the coca leaf.

FIG. 7 depicts the results of a gas chromatography mass spectrometry analysis of DIET COKE® soda (a similar analysis appears in the bottom graph of FIG. 8). The peak at a retention time of 16.76 is caffeine (very much similar to the main peak of FIG. 5 for COCA-COLA® soda), and the peak at retention time of 12.39 is probably a combination of terpin and terpine-4-ol (again similar to 12.39 peak of FIG. 5). FIG. 7 also has a small peak at 18.29, mostly likely a cinnamate, again similar to FIG. 5. That is both COCA-COLA® and DIET COKE® are mostly sugar and caffeine, with very small amounts of flavoring (the terpenes and cinnamates, and cymene and limonene). The only significant difference between COCA-COLA® and DIET COKE® is the peak at 11.06—benzoic acid, a breakdown product of a preservative (currently potassium benzoate, was sodium benzoate) used in the less-acidic DIET COKE® (DIET COKE® uses less phosphoric acid, and uses some citric acid, to deal with aftertastes, which decreases the pH of DIET COKE®—creating a need for a preservative). This similar chemical composition is consistent with the formulation data in FIG. 1, that is, if you start with COCA-COLA® soda and remove all of the sugar and some of the phosphoric acid, and then add an artificial sweetener and sodium/potassium benzoate, the result is much the composition of DIET COKE®.

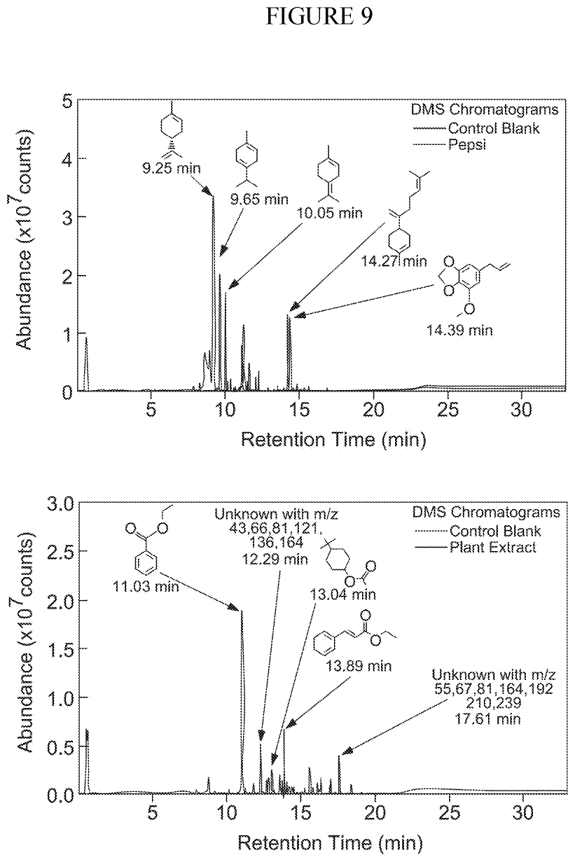

FIG. 9 depicts the results of desorption gas chromatography mass spectrometry of PEPSI® cola soda and coca leaf extracts, using Stir Bar Sorptive Extraction. Given the similarities in taste and aroma of COCA-COLA® and PEPSI® cola sodas, it is no surprise that PEPSI® shares with COCA-COLA® some of the same flavoring chemicals—limonene at a retention time of 9.25 and gamma-terpinene at a retention time of 9.65 (which are more dominant in PEPSI® cola soda). And much like COCA-COLA® sodas, there is a lack of overlap between the chromatograms of PEPSI® soda and coca leaf extracts, which is consistent with the fact that PepsiCo has never used the coca leaf in its cola sodas.

### Exemplary Embodiment #12

A water-based solution of alpha-terpineol was prepared, where the concentration of alpha-terpineol was 48 micrograms/milliliter. Alpha-terpineol is a monoterpene alcohol found in both COCA-COLA and DIET COKE® at similar concentration, and is said to have a weak, pleasant odor similar to lilac. About one teaspoon of this alpha-terpineol solution is added to 220 milliliters of DIET COKE®. The experience of drinking this modified DIET COKE® is more pleasant. For the embodiments disclosed herein that use coca leaf extract, the coca leaf extract can be augmented with alpha-terpineol, for example, adding from about 100 micrograms to about 300 micrograms of alpha-terpineol to each teaspoon of coca leaf extract. Similarly, one half of a teaspoon of gamma-terpinene (also a flavoring component of current cola sodas, with a pine oil smell), with a concentration of 40 micrograms/milliliter, is added to 220 milliliters of DIET COKE®. The resulting DIET COKE®, while more pleasant as seen with adding alpha-terpineol, also has less of a “coca cola” taste. In contrast, one teaspoon of linalool (which has a more pleasant aroma than many terpinenes)—also a component of cola sodas—also with a concentration of 40 micrograms per milliliter, is added to 220 milliliters of Diet Coke. There is little-to-no change in the unpleasantness.

These Embodiments suggest that the taste and/or aroma of existing diet cola sodas can be improved by increasing some of the flavoring chemicals already in such sodas, such as increasing the amount of alpha-terpineol, limonene and cinnamaldehyde. This may follow from FIG. 8, which has GCMS spectra of COKE® and DIET COKE®. While one cannot absolutely compare two GCMS spectra, the control peaks in both graphs has similar intensities to the extent that relative comparisons can be made. One such relative comparison is that COCA-COLA® soda appears to have slightly higher concentrations of the main flavoring chemicals than DIET COKE®. Other possible chemicals and or essential oils that can be similarly used appear in FIG. 11, a coca-cola flavoring for electronic cigarettes disclosed in Chinese Patent Application CN107125803A, titled “Electronic cigarette tar and preparation method thereof”; and also appear in FIG. 12, a synthetic cola aroma compound. In additional embodiments, for those existing diet colas using a cola flavoring with a similar composition to FIG. 12, new diet colas can be manufactured using the embodiments disclosed herein, where the concentrations of chemicals in FIG. 12 are altered. For example, if chemicals in both coca leaf extract and cola syrup are contributing to a “leafy” taste, the concentrations of these chemicals in a beverage or syrup can be decreased.

Synthetic Coca Leaf Extracts

In a subsequent GCMS analysis of the liquid form of ERC-A20 coca leaf extract, the concentrations of the main peaks of FIG. 4 were determined. Reference solutions in methanol (at 5 micrograms/milliliter) were prepared for ethyl benzoate and ethyl cinnamate. A reference solution was prepared for 1,4-dichlorobenzene at 5 micrograms/milliliter in dichloromethane, which was used for calibration purposes. For ethyl benzoate, its concentration as determined by GCMS analysis in the sample of the ERC-A20 is approximately 12 micrograms per milliliter (12.13). For ethyl cinnamate, its concentration as determined by GCMS analysis in the sample of the ERC-A20 is approximately 1.4 micrograms per milliliter (1.438).

ERC-A20 coca leaf extract in liquid form has a dark brown color. A QTOF-LCMS analysis of a sample of the extract detected the presence of caffeic acid and its isomers, as well as chlorogenic acids and their isomers (an important constituent of coffee, chlorogenic acid, also known as a caffeoylquinic acid—CQA—is the ester form of caffeic acid).

### Exemplary Embodiment #13

In a variant of Exemplary Embodiment #1, about 5 milliliters (one teaspoon) of a liquid (e.g., water) solution that has about 24 micrograms per milliliter of ethyl benzoate is used instead of about one teaspoon of coca leaf extract (both of which are mixed with 7.5 ounces of DIET COKE®). A taste and/or aroma more pleasant than that of untreated DIET COKE® results, though with less of an improvement than can be achieved by adding coca leaf extracts. For all of the Exemplary Embodiments disclosed herein, wherever about one teaspoon of coca leaf extract is used, new embodiments can be derived by substituting for the extract, about one teaspoon of a liquid solution of ethyl benzoate of a concentration of about 24 micrograms per milliliter. For other embodiments, at least one microgram per milliliter of ethyl benzoate is added to any diet soda beverage or syrup. The concentration and amount of ethyl benzoate varies according to taste. Using just ethyl benzoate to improve the taste of diet sodas mostly does not change the manufacturing cost. The teaspoon of ethyl benzoate solution used in the above introductory example has 100 micrograms of ethyl benzoate. 100 grams of ethyl benzoate can be purchased from Sigma-Aldrich at a cost of about 30 dollars. 100 micrograms thus costs 0.0030 cents—a negligible cost per serving of a soda beverage. In some of the embodiments disclosed herein, one to three drops (about 0.35 milligrams) of liquid saccharin (SWEET'N LOW®) are used per teaspoon of coca leaf extract or ethyl benzoate solution.

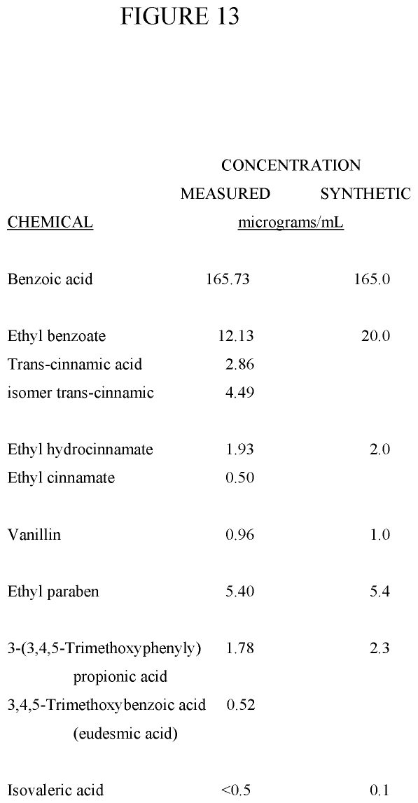

An additional GCMS study was performed liquid ERC-A20 extract was, and concentrations of some of the more abundant chemicals in the extract were quantified. This data is seen in the “MEASURED” column of data in FIG. 13. A synthetic coca leaf extract was prepared based on the “MEASURED” data, using the chemical concentrations in the “SYNTHETIC” column of data in FIG. 13. While the synthetic coca leaf extract improves the taste of DIET COKE®, comparable to the increased pleasantness using the full extract (with or without additional sweetener such as 6 grams of sucrose). Synthetic leaf extracts with similar relative amounts of the chemicals of FIG. 13 can be used in some of the embodiments disclosed herein. For all of these synthetic embodiments, ethyl acetate, 3-methylbutanol, 3-methylbutanal, eucalyptol and trimethyl oxazole, in microgram per milliliter quantities, can be added to the synthetic extracts.

In a variant of Exemplary Embodiment #13, about 5 milliliters of a liquid (e.g., water) solution of methyl benzoate is used that has a similar concentration to about 24 micrograms per milliliter, achieving an improvement in DIET COKE® taste similar to that of using ethyl benzoate. While methyl benzoate can be used in the embodiments disclosed herein for commercial purposes, methyl benzoate has two known uses not completely compatible with a consumer beverage. First, methyl benzoate is one of the breakdown products of cocaine (in humid atmospheres, the acidic cocaine reacts with water in the air), and its odor is used by drug control drugs to detect the smuggling of cocaine—government authorities will not be keen to having diet sodas, using methyl benzoate, filling the airspaces of public places with the aroma of methyl benzoate. Second, methyl benzoate is also attractive to the males of various species of orchid bees, and is commonly used as bait to attract such bees—not a use compatible with consumer beverages, for example, at picnics or ballparks. Related benzoates may be used, for example propyl benzoate (nutty odor with sweet fruit taste, used as preservative in cosmetics), benzyl benzoate (weak, sweet, balsamic odor, used to as a fixative in perfumes), and phenethyl benzoate (slight rose scent—used in cosmetics).

The presence of ethyl benzoate and other ester benzoates in the embodiments disclosed herein can be objectively tested for by using techniques such as GCMS, that is, one can differentiate cola sodas with regards to their use of the compositions disclosed herein by using GCMS techniques or by using spike analysis, useful for detecting infringement of the methods disclosed herein.

Using Chemicals with Similar Odors

Esters, which often have a distinct fruit-like odor, are chemical compounds which can be derived from carboxylic acids in which at least one —OH (hydroxyl) group is replaced by a —O-alkyl. Ethyl benzoate, e.g., can be derived from an alkyl, ethyl (C₂H₅*), and a carboxylic acid, benzoic acid (C₇H₆O₂). For embodiments disclosed herein that use ethyl benzoate or methyl benzoate to improve the taste and/or aroma of diet sodas, alternative chemical compounds that similarly improve taste and/or aroma can be used. These alternative chemicals can be chosen using the shape theory of olfaction. Aromatic chemicals can be screened, for example, with (Q)SAR analysis to identify other chemicals useful for making diet sodas that have a more pleasant taste.

### Exemplary Embodiment #14

While many of the embodiments disclosed herein are used to make diet cola sodas have tastes/aromas closer to that of sugary cola sodas, the taste/aroma of sugary sodas is not that “strong” given the large amount of sugar used. In a variant of Exemplary Embodiment #1, instead of adding just one to two teaspoons of liquid ERC-A20 coca leaf extract, about three, four, five or more teaspoons can be added (or one teaspoon of a five-times concentrated liquid ERC-A20 coca leaf extract). This embodiment could be the basis of a “coca-coca-cola” soda.

### Exemplary Embodiment #15

In 2006, Coca-Cola started selling COCA-COLA BLāK®, a coffee-flavored cola soda, which it cancelled as a product in 2007 (ten years earlier, PepsiCo tried something similar—PEPSI KONA®). The intent was to get people to make cola soda a part of their breakfast, or more part of their lunch or dinner when they might drink coffee, an intent that failed. An alternative is a “darker” cola soda (similar in spirit to a dark chocolate). Another embodiment of the inventions disclosed herein initially comprises 220 milliliters of DIET COKE®, and about one teaspoon of coca leaf extract, and one bag (about 5 grams) of sugar (Embodiment #11). To this mixture is added a second or third teaspoon of coca leaf extract, a 50% to 100% increase in the amount of caffeine (a typical can of cola soda has about 35 milligrams of caffeine, so up to another 35 milligrams of caffeine would be added), while reducing the amount of sugar and aspartame by 50%. The resulting is a “stronger” tasting cola soda that still is a cola soda, without triggering the consumer confusion of adding coffee to cola sodas.

Manufacturing Techniques

Existing manufacturing processes for diet cola sodas and syrups are easily modified to use the methods disclosed herein. Where mixing tanks are used to prepared the soda or syrup, an additional pipe can be attached to allow a controlled flow of (synthetic) coca leaf extract or ethyl benzoate solution, to be mixed in with other ingredients. These extracts/solutions are liquid at room temperature, and easy to transport and safely mix with mechanical equipment. Where powdered coca leaf extracts are used, they can be mixed with other granular materials currently used in the manufacture of sodas, such any of the powdered sweeteners currently used.

Null Taste Control Test #1

About one teaspoon of liquid ERC-A20 coca leaf extract is added to 220 milliliters of sugary COCA-COLA® (“sabor original” in Latin America). There is little-to-no change in the pleasant taste of the beverage, with the coca leaf taste and/or aroma more noticeable.

Null Taste Control Test #2

In one experiment, a pulverized multivitamin pill (Centrum Men) is added to 220 milliliters of DIET COKE®. There is little-to-no change in the unpleasantness of Diet Coke. A typical multi-vitamin/multi-mineral pill (such as CENTRUM MEN®) has the usual vitamins (A, Bs, C, D, E, K, etc.) and minerals (calcium, iron, phosphorus, iodine, magnesium, zinc, potassium, etc.). The lack of appreciable change in taste and/or aroma implies that these vitamins and minerals, some also present in coca leaf extracts, are not essential to embodiments disclosed herein.

Null Taste Control Test #3

One nutritional supplement, popular for flavoring foods, is cinnamon. In one experiment, 400 milligrams of powdered cinnamon are added to 220 milliliters of DIET COKE®. No improvement in “Coca-Cola” taste and/aroma is experienced, but rather the additive taste of DIET COKE® plus cinnamon. This effect has been exploited by PepsiCo with its sugary PEPSI FIRE® cinnamon flavored cola. The main chemical that gives cinnamon its flavor and aroma is cinnamaldehyde. Cinnamon oil contains a variety of chemicals, including cinnamaldehyde, limonene, linalool, and eugenol. Cinnamon oil, or any or all of its component chemicals, can be added to the embodiments disclosed herein.

Null Taste Control Test #4

A tea similar in “delicious” taste to coca tea is jasmine tea, a popular green tea from SouthEast Asia, a mixture of base green tea leaves and aromatic flowers from the Jasminum sambac plant. Unlike coca tea, jasmine tea contains no alkaloids, but does contain many chemical common to all teas, including flavonoids, phenols and saponin. Some of the major taste and aroma components of jasmine tea (depending on variety and preparation) can include linalool (a terpene alcohol found in some analyses of COCA-COLA® soda), benzyl acetate (which independently provides a “jasmine” aroma), hexenyl benzoate, benzyl alcohol, and methyl anthranilate (which can provide a “fruity” aroma in perfumes). (see “Changes in the volatile, chemical components and antioxidant activities of Chinese jasmine tea during the scenting process”, Meichun Chen et al., Int. J. of Food Properties, Volume 20, 2017). In one experiment, one bag of Celestial Organic “Jasmine Green” tea is brewed for two minutes in 60 milliliters of hot water, cooled to room temperature, and added to 220 milliliters of Diet Coke. No improvement in “CocaCola” taste and/or aroma is experienced, but rather the additive taste of DIET COKE® plus jasmine tea.

Null Taste Control Test #5

In one experiment, one drop (about a quarter of a smidgen, which is 1/32th of a teaspoon) of bergamot oil (“Bergamota” sold by Aromas Para El Alma, Costa Rica) is added to 220 milliliters of DIET COKE®. No improvement in “Coca-Cola” taste is experienced, but rather the additive taste of DIET COKE® plus bergamot oil. While bergamot oil typically can be about 50% limonene and gamma-terpinene, two cola flavoring chemicals, it is also can be about 10% by weight of pinene (a major component of pine oil, known to be an off-flavor in mango juice made from overripe mangos).

Null Taste Control Test #6

Use of methyl benzoate in some of the embodiments disclosed herein suggests use of other methyl esters. One such other methyl ester is methyl 2-hydroxybenzoate, the methyl ester of salicylic acid (aspirin is acetylsalicylic acid), better known as wintergreen oil. Wintergreen oil has had some use in the soda industry. After the FDA banned the use of safrole in root beer (a chemical found in sassafras, a classic ingredient in root beer), the root beer industry substituted a combination of licorice root and wintergreen. In one experiment, one drops of wintergreen oil (Nature's Oil Organic Wintergreen Essential Oil) is added to 220 milliliters of DIET COKE®. The resulting taste is dominated by the taste of wintergreen, which while being the basis for a wintergreen soda, does not seem effective in improving the “cola” taste and/or aroma of DIET COKE®, except maybe in much smaller quantities.

Null Taste Control Test #7

In one experiment, 1/32^{nd} of a teaspoon of sodium benzoate (density: 1.5 g/cm³) is added to 220 milliliters of DIET COKE® (a total weight of 230 milligrams, versus 100 micrograms of ethyl benzoate in some of the above embodiments). No improvement in “Coca-Cola” taste is experienced, but rather the additive taste of DIET COKE® plus saltiness. Sodium benzoate doesn't have much of an odor, and a bit of an unpleasant taste. Sodium benzoate was used for decades by Coca-Cola and Pepsico only as a preservative, before being replaced with potassium benzoate (at least in the U.S.), due to health concerns of a breakdown product, benzoic acid. Similar lack of a change of taste is expected when adding potassium benzoate, as both chemicals are used interchangeably in Coca-Cola and Pepsi around the world.

“Diet” Chocolate Milk and Cream

Much like cola soda beverages, chocolate uses (a lot of) sugar because of the unpleasant taste of cacao, with the chocolate industry using millions of tons of sugar each year. Much of the unpleasant taste of cacao is mainly due to its acidity, an unpleasantness which can be reduced by raising the pH from about a pH of 5.5 to about a pH of 6.6 for cacaos used to make chocolate (or instead use a naturally low-acidity cacao). One method for adjusting the pH of cacao is the chemically-harsh Dutch process applied during cacao refining (which uses the strongly alkaline chemical, potassium carbonate). Related to the problem of acidity is astringency, which can cause a “puckering” effect in the mouth when some foods are consumed. This acidity-related unpleasant taste can be experienced with the following experiment. Prepare two cups containing one or two tablespoons of unsweetened cacao powder. To one cup, add hot water at a temperature near boiling. To the other cup, add room temperature water. Many people can drink the room temperature mixture (maybe without a lot of enjoyment), but these same people find it difficult to drink the near-boiling temperature mixture. Temperature of a solution is known to affect the acidity of such mixtures.

Some of the unpleasant taste of unsweetened cacao can be removed by using ethyl benzoate. In one exemplary embodiment to improve the taste of any brand of unsweetened cacao and/or chocolate made therefrom, prepare one cup of hot water and add about two tablespoons of unsweetened HERSHEY® cacao powder. Mix in 5 milliliters (one teaspoon) of a liquid (e.g., water) solution that has, for example, 24 micrograms per milliliters of ethyl benzoate. The resulting beverage is more pleasant, and can be consumed with an enjoyment somewhat similar to that experienced when drinking black coffee. The resulting taste and/or aroma of the cocoa is not that of traditional hot chocolates, the taste of chocolate being much due to sugar. In other embodiments, instead of mixing in a pure solution of ethyl benzoate, one can mix in an extract of a plant where the extract has a similar concentration of ethyl benzoate, such as the ERC-A20 extract discussed in some of the embodiments disclosed herein.

In another exemplary embodiment, chocolate milk is manufactured without using added sugar, as follows. First, mix two tablespoons of unsweetened cacao (such as HERSEY UNSWEETENED CACAO®, regular or Dutch-processed) into one or two cups of milk, hot or cold. Next mix in one bag of an artificial sweetener, such as cyclamate-based Sugar Twin (0.8 grams). The result is a chocolate milk drink with no added sugar, that is similar in taste and/or aroma to current chocolate milks with their 12 to 24 grams of added sugar. One can additionally add in 5 milliliters (one teaspoon) of a liquid (e.g., water) solution that has 24 micrograms per milliliter of ethyl benzoate.

In another exemplary embodiment, a powder-based product for making chocolate drinks comprises about two tablespoons of unsweetened cacao powder, and a powder that contains ethyl benzoate, for example, about two teaspoons of a powdered version of the ERC-A20 extract discussed in some of the embodiments disclosed herein. Such a powdered product can be packaged and sold in a form similar to existing hot chocolate powders, such as those powdered hot chocolate mixes available from Swiss Miss.

In another embodiment, a very-low fat, sugar-free, chocolate cream is manufactured, for example, using the following formulation: 220 grams of unsweetened cacao, for example, Hershey's Dutch-processed Unsweetened Cacao; 320 grams of a fine-particle milk protein powder; about 10 grams of sodium cyclamate; about 15 grams of sodium propionate; about 2.5 cups of water; and about 15 to 30 milliliters (one to two tablespoons) of a liquid (e.g., water) solution that has 24 micrograms per milliliter of ethyl benzoate. Thoroughly mix the powders and additives in a bowl, and then gradually add the water while stirring. Continue stirring until a desired cream texture is achieved. Gram quantities of other flavorings, such as salt, vanilla and cinnamon, can be added to create related pleasant tastes. An anti-caking agent, such as tricalcium phosphate or cellulose, can be used to decrease stickiness of the cream. The cream can be used to make an ice cream.

An improved chocolate cream can be produced by using a mostly fat-free microparticulated protein concentrate such as SIMPLESSE® microparticulated whey protein concentrate manufactured by CPKelco. Such a protein comprises microparticles averaging one micron in diameter, which create an improved mouthfeel as compared to using other whey protein powders, and creates an improved mouthfeel as compared to using fatty milk creams, or other fats such as cacao butter or palm oil (which is used in Nutella creams).

The use of sodium propionate as an anti-molding agent is due to the healthier nature of such very-low fat, sugar-free, chocolate cream as described above. Traditional chocolate creams use little to no water, use untreated acidic cacao, and use lots of sugar—all conditions that suppress microbial growth. The chocolate cream described above uses a lot of water, using low-acidic cacao, and uses no sugar—conditions favorable to microbial growth. Such growth can be treated using preservatives such as sodium propionate. More acidic cacaos can be used to suppress microbial growth while not impacting taste by using a taste modifier such as miraculin, which binds to sweet receptors on the tongue so that sour foods are perceived as sweet. Another method to suppress microbial growth is to use water that incorporates nanoparticle colloidal silver, such as Purest Colloids' MESOSILVER®. Silver colloids are known to have anti-microbial properties. Another antimicrobial ingredient for the improved chocolate creams described above, where some sugar is used, is Manuka honey, which is known to have antimicrobial effects.

Low sodium, less sugary, diet peanut butters, such as J. M. Smucker's SIMPLY-JIF®, are consumed with the same psychology as are diet sodas—you have to (for less sugar) not that you want to. An improved diet peanut butter can be produced, for example, by adding one teaspoon of the coca leaf extracts disclosed herein, or their equivalents, to one tablespoon of diet peanut butters, such as SIMPLY-JIF®.

Products with Coca Leaf Extracts and Nicotine

It is well-known and useful to add nicotine to consumer beverages to make the products more addictive (especially products that contain partially addictive caffeine, for example, as seen in U.S. Pat. No. 6,749,882—Coffee having a nicotine composition dissolved therein). A typical cigarette provides a nicotine fix of up to 4 milligrams of nicotine, though any amount can be used, for example, as much as 10 to 20 milligrams of nicotine. Nicotine is one of the most toxic and addictive chemicals legally sold to consumers, with a density of about 1.01 grams per cubic centimeter (similar to that of water). What is useful in commerce, and a novel use, is to add nicotine to a food or beverage product to be able to make the highly useful legal argument that the adding a new chemical to food or beverage that is not addictive, not toxic, but most illegally, is an unconstitutional restraint of trade. This new chemical is the coca alkaloid.

In some of the embodiments where 220 milliliters of the soda products are disclosed herein, a quantity of nicotine is added in the range of 1 to 20 milligrams, or for other quantities of soda, the percentage of nicotine ranges up to 20% of the total volume of the quantity of soda.

Coca Leaf Extract that Includes Alcohol

In some versions of coca leaf extract, ethanol is included as a preservative. This allows the extract to be stored for many years with little-to-no degradation. This information is not explicitly provided by one manufacturer of coca leaf extracts, ENACO of Peru.

HGCMS quantitation of a sample of the ERC-A20 extract was performed. A sample stock was prepared by taking an aliquot of the provided Plant Extract (100 μL) and diluting by a factor of 100 by adding 9.9 mL of 10 μg/mL solution of IPA-d₈ internal standard in water. The same internal standard containing diluent was used as the solvent for all standard and sample preparation. For the quantitation analysis, a 200 μL aliquot of the sample stock (100× diluted) was further diluted with 800 μL of diluent, resulting in a final sample dilution factor of 500. The sample solution was then subjected to HGCMS analysis without further preparation.

To evaluate the accuracy of the quantitation, a sample spike was prepared: a 200 μL aliquot of the sample stock (100× diluted) was spiked with 200 μL of 1000 μg/mL ethanol stock and 600 μL of diluent, resulting in a sample dilution factor of 500 and a spiked concentration of 200 μg/mL. The spiked sample was subjected to HGCMS analysis with the sample solution.

All of the samples were analyzed using an HP 6890A gas chromatograph in conjunction with a 5972 mass selective detector. Sample peaks were compared with about 800,000 reference compounds using the NIST/EPA/NIH mass spectral search program. The initial temperature of samples was 45° C., and the final temperature was 250° C.

For the coca leaf plant extract samples analyzed, the average concentration of ethanol in the liquid solution was about 13% ABV (alcohol by volume). In comparison, naturally occurring fruit juices have an ABV of 0.00% to 0.09%, beer typically has an ABV of 4.0% to 6.0% percent, wine often has an ABV of 12% to 15%, and many vanilla extracts have an ABV of over 30%. For products that cannot include ethanol as an ingredient, coca leaf extracts can be prepared that don't include ethanol (presumably such extracts are shipped to beverage and food manufacturing facilities for immediate use in the bottling process). For products that can include alcohol, when 5 milliliters of coca leaf extract is added to the 220 milliliter embodiments disclosed herein (or their equivalents), this addition will add about 0.65 milliliters of ethanol to the 220 milliliters of soda, leading to a level of 0.29% ABV. By U.S. law, a beverage is non-alcoholic if the amount of alcohol is 0.05% ABV. If the amount of alcohol in coca leaf extract is reduced to less than 2%, then when used in food and beverage products, its use will be less than 0.05% ABV. Of course, some embodiments can make use of much higher levels of ethanol for some of the embodiments of beverages disclosed herein, but explicitly sold as alcoholic beverages.

Chlorogenic Acid

In earlier analyses, the presence of chlorogenic acids and their isomers were detected in coca leaf extract (as determined by QTOF-LCMS analysis). Additional analyses were performed using Pyrolysis Gas Chromatography Mass Spectrometry (PYMS) and Fourier Transform Infrared Spectroscopy (FTIR), which confirmed the presence of chlorogenic acids. A typical cup of coffee of 220 milliliters has been measured to have between 60 and 360 milligrams of chlorogenic acid. Similar amounts of chlorogenic acid can be added to some of the 220 milliliter embodiments disclosed herein.

The disclosure comprises at least the following additional embodiments/aspects.

Aspect 1. A diet cola beverage product with an improved taste, comprising, consisting of, or consisting essentially of ethyl benzoate.

Aspect 2. A diet cola beverage product with an improved taste, comprising, consisting of, or consisting essentially of: a diet cola beverage product; and an extract of a coca leaf plant.

Aspect 3. The diet cola beverage of Aspect 2, where the extract of the coca leaf plant is de-cocainized.

Aspect 4. The diet cola beverage of any one of Aspects 2-3, where the extract of the coca leaf plant is in liquid form.

Aspect 5. The diet cola beverage of Aspect 4, where the liquid coca lead extract is ERC-A20 sold by the Empresa Nacional de la Coca of Lima, Peru, or a chemically similar coca leaf extract.

Aspect 6. The diet cola beverage of any one of Aspects 2-5, where the diet cola beverage product and the extract of the coca leaf plant are combined at a ratio by weight of approximately 22:1 to 44:1.

Aspect 7. The diet cola beverage of any one of Aspects 2-6, where the extract of the coca leaf plant comprises: one or more ingredients selected from ethyl benzoate, benzoic acid, trans-cinnamic acid, ethyl cinnamate, ethyl vanillate, eudesmic acid, ethyl acetate, 3-methylbutanol, 3-methylbutanal, eucalyptol and trimethyl oxazole or a combination thereof.

Aspect 8. The diet cola beverage of any one of Aspects 2-7, further comprising an additional artificial sweetener which is a combination of sodium cyclamate and saccharin.

Aspect 9. A diet cola syrup with an improved taste, comprising, consisting of, or consisting essentially of: a diet cola syrup; and an extract of a coca leaf plant.

Aspect 10. The diet cola syrup of Aspect 9, where the extract of the coca leaf plant is de-cocainized.

Aspect 11. The diet cola syrup of any one of Aspects 9-10, where the extract of the coca leaf plant is in liquid form.

Aspect 12. The diet cola syrup of Aspect 11, where the liquid coca lead extract is ERC-A20 sold by the Empresa Nacional de la Coca of Lima, Peru, or a chemically similar coca leaf extract.

Aspect 13. The diet cola syrup of any one of Aspects 9-12, where the diet cola beverage product and the extract of the coca leaf plant are combined at a ratio by weight of approximately 22:1 to 44:1.

Aspect 14. The diet cola syrup of any one of Aspects 9-13, where the extract of the coca leaf plant comprises: one or more ingredients selected from ethyl benzoate, benzoic acid, trans-cinnamic acid, ethyl cinnamate, ethyl vanillate, eudesmic acid, ethyl acetate, 3-methylbutanol, 3-methylbutanal, eucalyptol and trimethyl oxazole or a combination thereof.

Aspect 15. The diet cola syrup of any one of Aspects 9-14, further comprising an additional artificial sweetener which is a combination of sodium cyclamate and saccharin.

Aspect 16. A method for improving a diet cola beverage product having a specified taste comprising, consisting of, or consisting essentially of improving the specified taste of the diet cola beverage product by adding to the diet cola beverage product an extract of a coca leaf plant.

Aspect 17. A method for improving a diet cola syrup having a specified taste comprising, consisting of, or consisting essentially of improving the specified taste of the diet cola syrup by adding to the diet cola syrup an extract of a coca leaf plant.

Aspect 18. An improved method of manufacturing a cola soda product, comprising, consisting of, or consisting essentially of importing de-cocainized coca leaf extract from South America, and adding the de-cocainized coca leaf extract to the cola soda product in a manufacturing process.

Aspect 19. A diet cola beverage product with an improved taste, comprising, consisting of, or consisting essentially of at least one microgram of ethyl benzoate per milligram of the beverage product.

Aspect 20. The diet cola beverage of Aspect 19, further comprising at least 0.1 microgram per milliliter (e.g., or in a range of one or more of: about 0.1 microgram per milliliter to about 0.5 microgram per milliliter, about 0.1 microgram per milliliter to about 1 microgram per milliliter, about 0.1 microgram per milliliter to about 5 microgram per milliliter, about 0.1 microgram per milliliter to about 10 microgram per milliliter, about 0.1 microgram per milliliter to about 20 microgram per milliliter, about 0.1 microgram per milliliter to about 50 microgram per milliliter, about 0.1 microgram per milliliter to about 75 microgram per milliliter, about 0.1 microgram per milliliter to about 100 microgram per milliliter) of one or more ingredients (e.g., or chemicals) selected from trans-cinnamic acid, ethyl cinnamate, chlorogenic acid, ethyl vanillate, eudesmic acid, ethyl acetate, 3-methylbutanol, 3-methylbutanal, eucalyptol and trimethyl oxazole or a combination thereof.

Aspect 21. A diet cola syrup with an improved taste, comprising, consisting of, or consisting essentially of: a diet cola syrup; and at least one microgram of ethyl benzoate per milligram of the beverage product.

Aspect 22. The diet cola syrup of Aspect 21, further comprising at least 0.1 microgram per milliliter (e.g., or in a range of one or more of: about 0.1 microgram per milliliter to about 0.5 microgram per milliliter, about 0.1 microgram per milliliter to about 1 microgram per milliliter, about 0.1 microgram per milliliter to about 5 microgram per milliliter, about 0.1 microgram per milliliter to about 10 microgram per milliliter, about 0.1 microgram per milliliter to about 20 microgram per milliliter, about 0.1 microgram per milliliter to about 50 microgram per milliliter, about 0.1 microgram per milliliter to about 75 microgram per milliliter, about 0.1 microgram per milliliter to about 100 microgram per milliliter) of one or more ingredients (e.g., or chemicals) selected from trans-cinnamic acid, ethyl cinnamate, chlorogenic acid, ethyl vanillate, eudesmic acid, ethyl acetate, 3-methylbutanol, 3-methylbutanal, eucalyptol and trimethyl oxazole or a combination thereof.

Aspect 24. A method for improving the taste of a diet cola beverage product comprising, consisting of, or consisting essentially of adding ethyl benzoate to the diet cola beverage product.

Aspect 25. A method for improving the taste of a diet cola syrup comprising, consisting of, or consisting essentially of adding ethyl benzoate to the diet cola syrup.

Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise. The term “about” as used herein can allow for a degree of variability in a value or range, for example, within 10%, within 5%, or within 1% of a stated value or of a stated limit of a range, and includes the exact stated value or range. While “about” permits some tolerance, a person of ordinary skill in the art would read the specification in light of his knowledge and skill for guidance on the level of that tolerance, and be reasonably apprised to a reasonable degree the metes and bounds of the claims.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B. Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes. “Optional” or “optionally” means that the subsequently described event or circumstance may or may not occur, and that the description includes instances where said event or circumstance occurs and instances where it does not.

What is claimed:

1. A diet cola beverage product with an improved taste, comprising at least one microgram of ethyl benzoate per milligram of the beverage product.

2. The diet cola beverage of claim 1, further comprising at least 0.1 microgram per milliliter of one or more ingredients selected from trans-cinnamic acid, ethyl cinnamate, chlorogenic acid, ethyl vanillate, eudesmic acid, ethyl acetate, 3-methylbutanol, 3-methylbutanal, eucalyptol and trimethyl oxazole or a combination thereof.

3. A diet cola syrup with an improved taste, comprising: a diet cola syrup; and at least one microgram of ethyl benzoate per milligram of the beverage product.

4. The diet cola syrup of claim 3, further comprising at least 0.1 microgram per milliliter of one or more ingredients selected from trans-cinnamic acid, ethyl cinnamate, chlorogenic acid, ethyl vanillate, eudesmic acid, ethyl acetate, 3-methylbutanol, 3-methylbutanal, eucalyptol and trimethyl oxazole or a combination thereof.

5. A method for improving the taste of a diet cola beverage product comprising adding ethyl benzoate to the diet cola beverage product.

6. A method for improving the taste of a diet cola syrup comprising adding ethyl benzoate to the diet cola syrup.
